(19) United States
(12) Patent Application Publication
(10) Pub. No.: US 2019/0052665 A1
(43) Pub. Date: Feb. 14, 2019

(54) SECURITY SYSTEM

(71) Applicant: CORTEX INSIGHT LIMITED, London (GB)

(72) Inventors: Adrian MAHIEU, London (GB); Stephen KAPP, London (GB)

(73) Assignee: CORTEX INSIGHT LIMITED, London (GB)

(21) Appl. No.: 16/076,707

(22) PCT Filed: Feb. 10, 2017
(86) PCT No.: PCT/GB2017/050371

§ 371 Date: Aug. 9, 2018

(30) Foreign Application Priority Data
Feb. 10, 2016 (GB) 1602412.7

(51) Int. Cl. H04L 29/06; G06F 21/57; G06N 3/04

(52) U.S. Cl. CPC H04L 63/1433; G06F 2221/034; G06N 3/04; G06F 21/577

(57) ABSTRACT

A computer security system, comprising: a first input, adapted to receive threat data representing security threats; a second input, adapted to receive vulnerability data representing security vulnerabilities; a processor adapted to: identify a specific vulnerability of a computer entity in dependence on the threat data and the vulnerability data; assign the specific vulnerability a risk rating in dependence on the vulnerability data and the threat data; and to generate output data comprising an identifier of the specific vulnerability and its risk rating.

This invention relates to a computer security system. In particular, a system for and method of managing computer security in an organisation is described which allows for vulnerabilities in computer security to be assessed jointly with threats to the organisation and the mitigation of the vulnerabilities to be prioritised according to relevant criteria. This invention is especially relevant to computer security professionals although and also to any persons responsible for the security of organisations reliant on computer systems.

As computer systems become increasingly complex and interconnected the number of security vulnerabilities increases and it is becoming increasingly difficult—even for IT security professionals—to keep abreast of the latest security threats. Furthermore, when vulnerabilities are identified it is not always straightforward to determine which are most serious and require addressing first. Accordingly there is a need for systems which can assist in such determination, facilitate the deployment of security resources and monitor mitigation. This invention seeks to address at least some of these issues.

According to an aspect of the invention there is provided a computer security system, comprising: a first input, adapted to receive threat data representing security threats; a second input, adapted to receive vulnerability data representing security vulnerabilities; a processor (implemented, for example, as a mapping engine on a computer server) adapted to: identify a specific vulnerability of a computer entity in dependence on the threat data and the vulnerability data; assign the specific vulnerability a risk rating in dependence on the vulnerability data and the threat data; and generate output data comprising an identifier of the specific vulnerability and its risk rating.

Preferably, the processor is adapted (for example, by means of a prioritisation engine implemented as a further or as part of the same computer server) to identify a plurality of specific vulnerabilities of the computer entity and to generate output data comprising a list of identifiers of the specific vulnerabilities ordered according to their risk rating.

Preferably, the processor is adapted to identify a mitigation for the or a specific vulnerability and to incorporate details of the mitigation with the output data.

Preferably, the computer security system further comprises means for interacting with the computer entity to implement the mitigation.

Preferably, the threat data comprises an organisational data feed relating to the organisation of which the computer entity is a part, and the processor is adapted (for example, by means of a threat modelling engine, implemented as a further or as part of the same computer server) to determine from the organisational data feed a threat model of potential threats to the computing entity, each threat being associated with a threat risk rating.

The organisational data feed may comprise one or more of information relating to: security or regulatory requirements, use cases or functional requirements, business assets, external dependencies and controls or mitigations.

The processor may be adapted to categorise the threats in the threat model according to one or more of: threat type, source, target, technology, and timeliness. The categorisation of the threats may be according to an industry-standard model, for example one or more of STRIDE, OctoTrike, PASTA, ASF and OWASP.

Preferably, the computer security system further comprises a manual input, adapted to receive manual modification or approval of one or more of: threat and vulnerability data, threat model, and risk ratings.

Preferably, the processor is adapted (for example, by means of a vulnerability matching engine, implemented as a further or as part of the same computer server) to receive a vulnerability data feed from a computer entity vulnerability source, and optionally to maintain a database of vulnerabilities.

The vulnerability data feed may originate from a vulnerability scanning tool.

Preferably, updates to the database of vulnerabilities from the vulnerability data feed are determined by fuzzy-matching with a decision tree.

The vulnerability data feed may include a vulnerability risk rating and the processor may be adapted to import and use the vulnerability risk rating in determining the threat risk rating.

Preferably, the computer security system further comprises a third input, adapted to receive a threat intelligence data feed; wherein the processor is adapted to modify the risk rating in dependence on threat intelligence data determined from the threat intelligence data feed.

The threat intelligence data feed may comprise information on threats recently or currently being exploited.

Preferably, the system is further adapted to assess the quality of the threat intelligence data feed; more preferably, to receive a plurality of threat intelligence data feeds and to compare at least one feed against another.

Preferably, at least one data feed comprises text data and the processor is adapted use natural language processing to parse and determine information from the data feed. The natural language processing may comprise one or more of: Bayesian, TF-IDF, Recurrent Neural Network and Support Vector Machines models for Natural Language Processing (NLP).

Preferably, the processor is adapted to transmit the output data to a mobile device, such as a laptop, tablet or smartphone. The processor may be adapted to adapt the output data according to the status of a user of the system. The processor may be adapted to assign a user to mitigate the specific vulnerability and/or to receive feedback from the user on the mitigation of the specific vulnerability.

According to another aspect of the invention there is provided a method of operating a computer security system, comprising: receiving, at a first input, threat data representing security threats; receiving, at a second input, vulnerability data representing security vulnerabilities; identifying a specific vulnerability of a computer entity in dependence on the threat data and the vulnerability data; assigning the specific vulnerability a risk rating in dependence on the vulnerability data and the threat data; and generating output data comprising an identifier of the specific vulnerability and its risk rating.

Preferably, the method further comprises identifying a plurality of specific vulnerabilities of the computer entity and generating output data comprising a list of identifiers of the specific vulnerabilities ordered according to their risk rating.

Preferably, the method further comprises identifying a mitigation for the or a specific vulnerability and incorporating details of the mitigation with the output data. The method may further comprise interacting with the computer entity to implement the mitigation.

Preferably, the threat data comprises an organisational data feed relating to the organisation of which the computer entity is a part, and the method further comprises determining from the organisational data feed a threat model of potential threats to the computing entity, each threat being associated with a threat risk rating.

Preferably, the organisational data feed comprises one or more of information relating to: security or regulatory requirements, use cases or functional requirements, business assets, external dependencies and controls or mitigations.

Preferably, the method further comprises categorising the threats in the threat model according to one or more of: threat type, source, target, technology, and timeliness. Categorising the threats may be in accordance with an industry-standard model, for example one or more of STRIDE, OctoTrike, PASTA, ASF and OWASP.

Preferably, the method further comprises receiving manual modification or approval of one or more of: threat and vulnerability data, threat model, and risk ratings.

Preferably, the method further comprises receiving a vulnerability data feed from a computer entity vulnerability source and optionally maintaining a database of vulnerabilities.

The vulnerability data feed may originate from a vulnerability scanning tool.

Preferably, the method further comprises determining updates to the database of vulnerabilities from the vulnerability data feed by fuzzy-matching with a decision tree.

Preferably, the vulnerability data feed includes a vulnerability risk rating and the method further comprises importing and using the vulnerability risk rating to determine the threat risk rating.

Preferably, the method further comprises: receiving a threat intelligence data feed; and modifying the risk rating in dependence on threat intelligence data determined from the threat intelligence data feed. The threat intelligence data feed may comprise information on threats recently or currently being exploited.

Preferably, the method further comprises assessing the quality of the threat intelligence data feed; more preferably, receiving a plurality of threat intelligence data feeds and comparing at least one feed against another.

Preferably, at least one data feed comprises text data and the method further comprises using natural language processing to parse and determine information from the data feed. The natural language processing may comprise one or more of: Bayesian, TF-IDF, Recurrent Neural Network and Support Vector Machines models for Natural Language Processing (NLP).

Preferably, the method further comprises transmitting the output data to a mobile device, such as a laptop, tablet or smartphone.

Preferably, the method further comprises adapting the output data according to the status of a user of the system.

Preferably, the method further comprises assigning a user to mitigate the specific vulnerability. The method may further comprise receiving feedback from the user on the mitigation of the specific vulnerability.

Also provided is a computer security system adapted to receive via a first input data representing security threats; to receive via a second input data representing security vulnerabilities; to map the threats to the vulnerabilities; and to output a prioritised list of security recommendations.

In some embodiments there is provided a computer security system for assessing threats to a computing entity, comprising: a threat modelling engine (implemented, for example, as a first computer server), adapted to receive a plurality of input data relating to the computing entity and to determine from the data potential threats to the computing entity, each threat being associated with a threat risk rating; a mapping engine (implemented, for example, as a second or as part of the first computer server), adapted to receive a plurality of input data relating to known vulnerabilities of the computing entities, each vulnerability being associated with a vulnerability risk rating, and to match the vulnerabilities to the threats identified by the threat modelling engine; and a prioritisation engine (implemented, for example, as a third or as part of the first or second computer server), adapted to determine an overall risk rating for each vulnerability in dependence on the threat risk rating and the vulnerability risk rating.

Preferably, the system further comprises a database of computer system vulnerabilities. The system may be adapted to: process the input data and for each flaw or vulnerability; seek a match to an existing flaw or vulnerability stored in the database; and add a new or update an existing entry for the flaw or vulnerability in the database.

Preferably, the prioritisation engine is further adapted to receive input data relating to threat intelligence and to determine the overall risk rating for each vulnerability in dependence on the threat intelligence.

Preferably, the threats are dependent on at least one of: security requirements, use cases, external dependencies, controls and business assets.

Preferably, the threat modelling engine comprises a natural language processor adapted to parse the input data relating to the computing entity.

Preferably, the system is adapted to classify the threats and/or vulnerabilities.

Preferably, the system further comprises a vulnerability matching engine (implemented, for example, as a fourth or as part of the first, second or third computer server), adapted to maintain the database of computer system vulnerabilities. The vulnerability matching engine may receive vulnerability data from a security scanning tool. The input data may relate to known or detected flaws or vulnerabilities. Preferably, the vulnerability matching engine is adapted to process the vulnerability data and for each flaw or vulnerability to seek a match to an existing flaw or vulnerability stored in the database, then either add a new or update an existing entry for that flaw or vulnerability in the database. Preferably, the system is adapted to generate a list of vulnerabilities prioritised according to the overall risk rating determined for each vulnerability. Preferably, the system is adapted to filter the prioritised list, more preferably to produce different lists for different users of the system.

Preferably the system is adapted to transmit information regarding the security risk to the computing entity to a user device.

Preferably, the prioritisation engine further comprises a natural language processor adapted to parse the threat intelligence data. Alternatively, or in addition, the prioritisation engine may comprise an input to receive pre-parsed threat intelligence data. The system described may provide an end-to-end security solution, allowing specific threats to and/or vulnerabilities of an organisation to be identified, prioritised, managed, resolved and monitored.

In some embodiments there is provided a method of assessing threats to a computer system, comprising receiving via a first input data representing security threats; receiving via a second input data representing security vulnerabilities; mapping the threats to the vulnerabilities; and outputting a prioritised list of security recommendations.

In some embodiments there is provided a method of assessing threats to a computing entity, comprising: receiving a plurality of input data relating to the computing entity and determining from the data potential threats to the computing entity, each threat being associated with a threat risk rating; receiving a plurality of input data relating to known vulnerabilities of the computing entities, each vulnerability being associated with a vulnerability risk rating, and matching the vulnerabilities to the threats identified by the threat modelling engine; and determining an overall risk rating for each vulnerability in dependence on the threat risk rating and the vulnerability risk rating.

Preferably, the method further comprises maintaining a database of computer system vulnerabilities. Preferably, the method further comprises processing the input data and for each flaw or vulnerability seeking a match to an existing flaw or vulnerability stored in the database, then either adding a new or updating an existing entry for the flaw or vulnerability in the database.

Preferably, the method further comprises receiving input data relating to threat intelligence and determining the overall risk rating for each vulnerability in dependence on the threat intelligence.

Preferably, the method further comprises parsing the input data relating to the computing entity and processing the data with a natural language processor.

Preferably, the method further comprises parsing the threat intelligence data and processing the data with a natural language processor. Alternatively, or in addition, the method may comprise receiving pre-parsed threat intelligence data.

Preferably the method further comprises transmitting information regarding the security risk to the computing entity to a user device.

Further features of the invention are characterised by the dependent claims.

The invention also provides a computer program and a computer program product for carrying out any of the methods described herein, and/or for embodying any of the apparatus features described herein, and a computer readable medium having stored thereon a program for carrying out any of the methods described herein and/or for embodying any of the apparatus features described herein.

The invention also provides a signal embodying a computer program for carrying out any of the methods described herein, and/or for embodying any of the apparatus features described herein, a method of transmitting such a signal, and a computer product having an operating system which supports a computer program for carrying out the methods described herein and/or for embodying any of the apparatus features described herein.

The invention extends to methods and/or apparatus substantially as herein described with reference to the accompanying drawings.

Any feature in one aspect of the invention may be applied to other aspects of the invention, in any appropriate combination. In particular, method aspects may be applied apparatus aspects, and vice versa.

Equally, the invention may comprise any feature as described, whether in the description, and (where appropriate) the claims and drawings, either independently or in any appropriate combination.

Furthermore, features implemented in software may generally be implemented in hardware, and vice versa. Any reference to software and hardware features herein should be construed accordingly.

The following abbreviations are used in this document:
MSSP—managed security service provider
TF—IDF—frequency—inverse document frequency, a statistic reflecting word significance
CWE/CVE—Common Weaknesses Enumeration/Common Vulnerabilities and Exposures, formal lists of software weakness and information security vulnerabilities available at cwe.mitre.org and cve.mitre.org
NLP—Natural Language Processing

The terms flaw and vulnerability may be used interchangeably, although generally vulnerability is to be understood to mean a verified flaw.

The invention will now be described, purely by way of example, with reference to the accompanying drawings, in which:

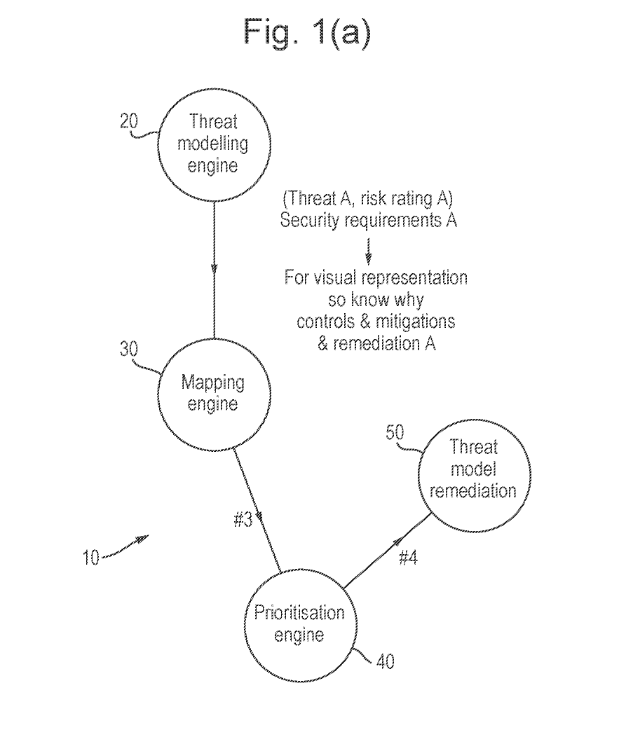

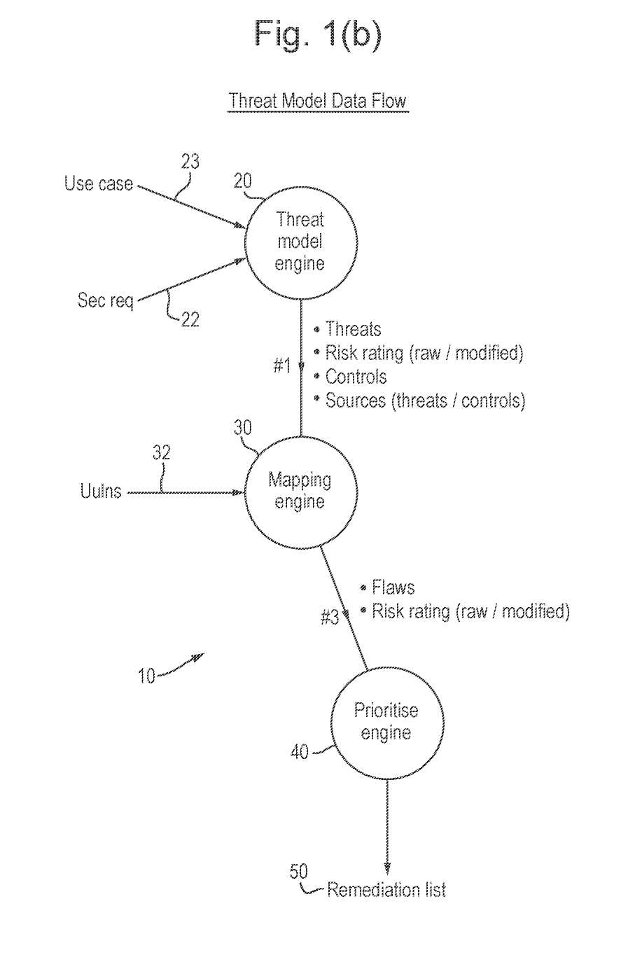

FIG. 1 shows a computer security system;

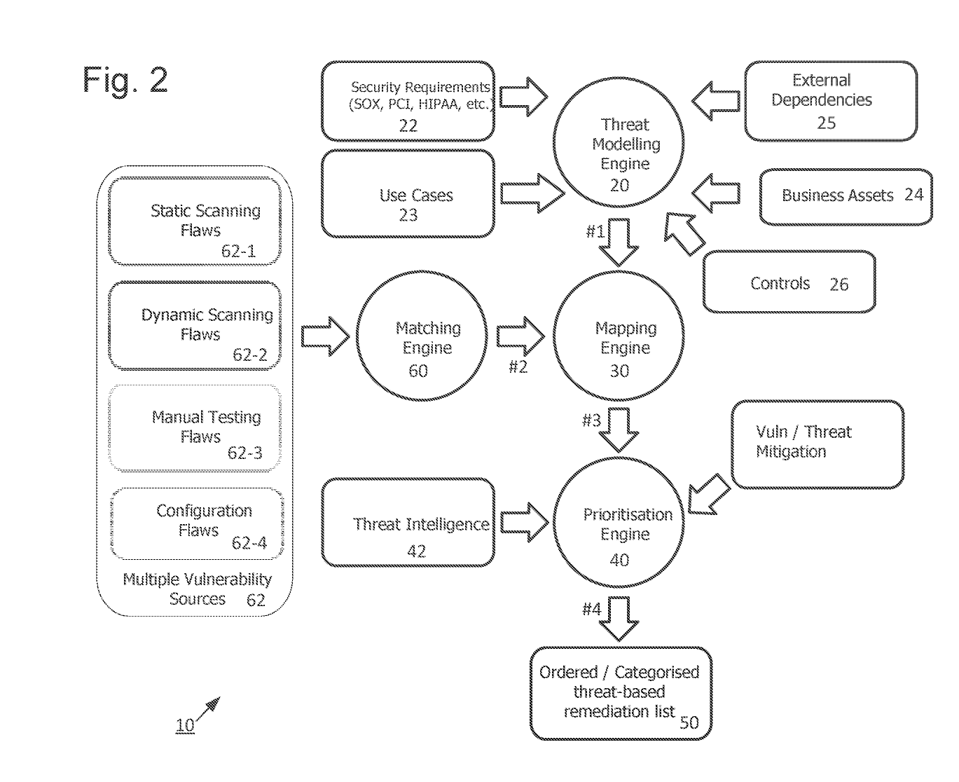

FIG. 2 shows another embodiment of the computer security system;

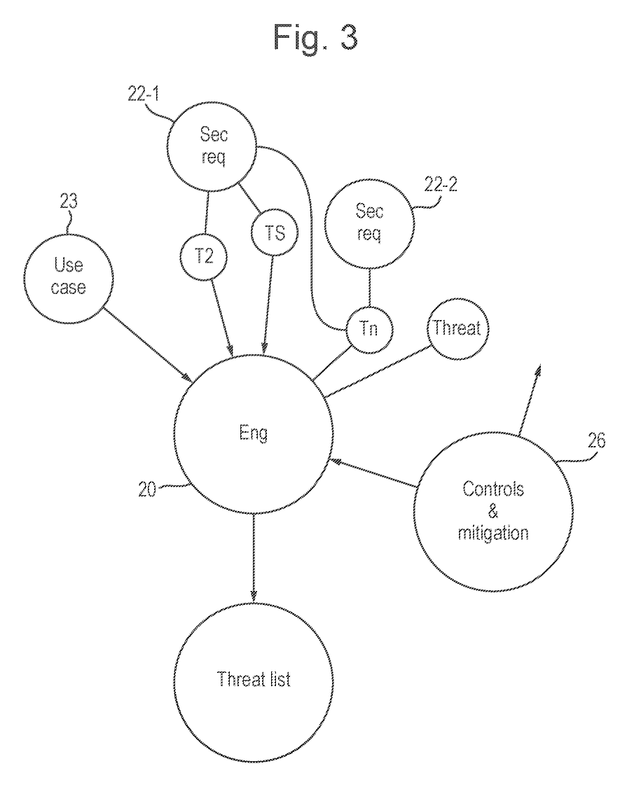

FIG. 3 shows the data feed inputs and output of threat modelling engine;

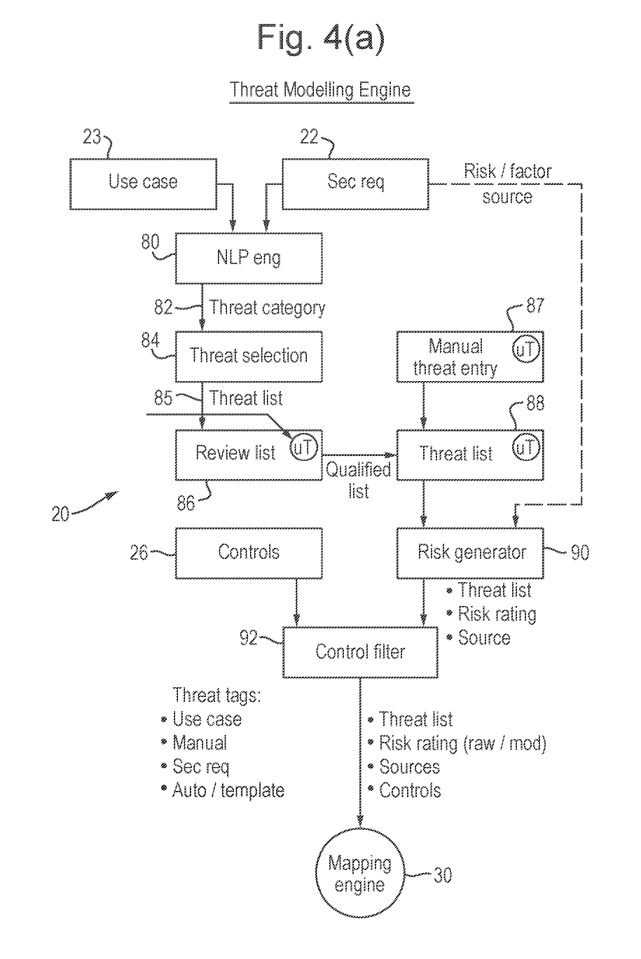

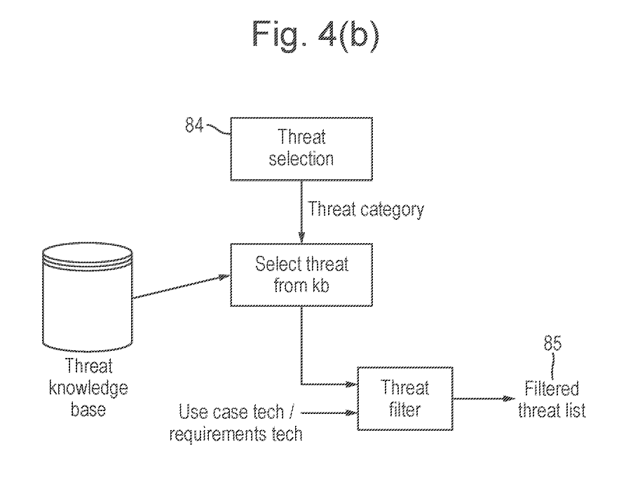

FIG. 4 shows the data flow in the threat modelling engine;

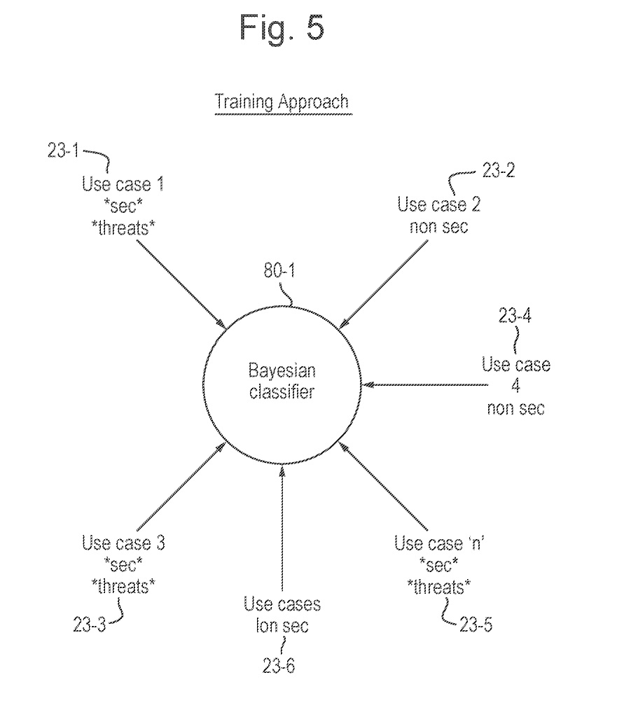

FIG. 5 shows threat classifier of the threat modelling engine in training mode;

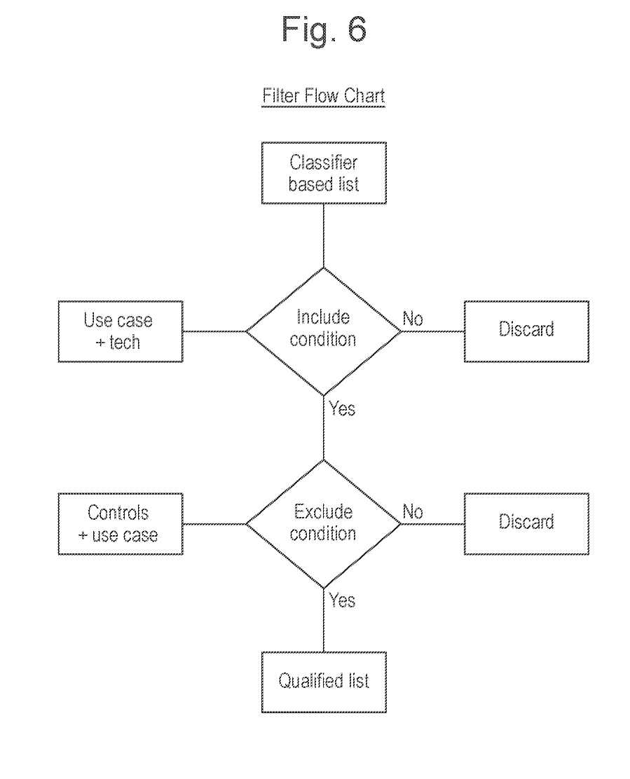

FIG. 6 shows an example filter flowchart for determining a threat list in dependence on use cases;

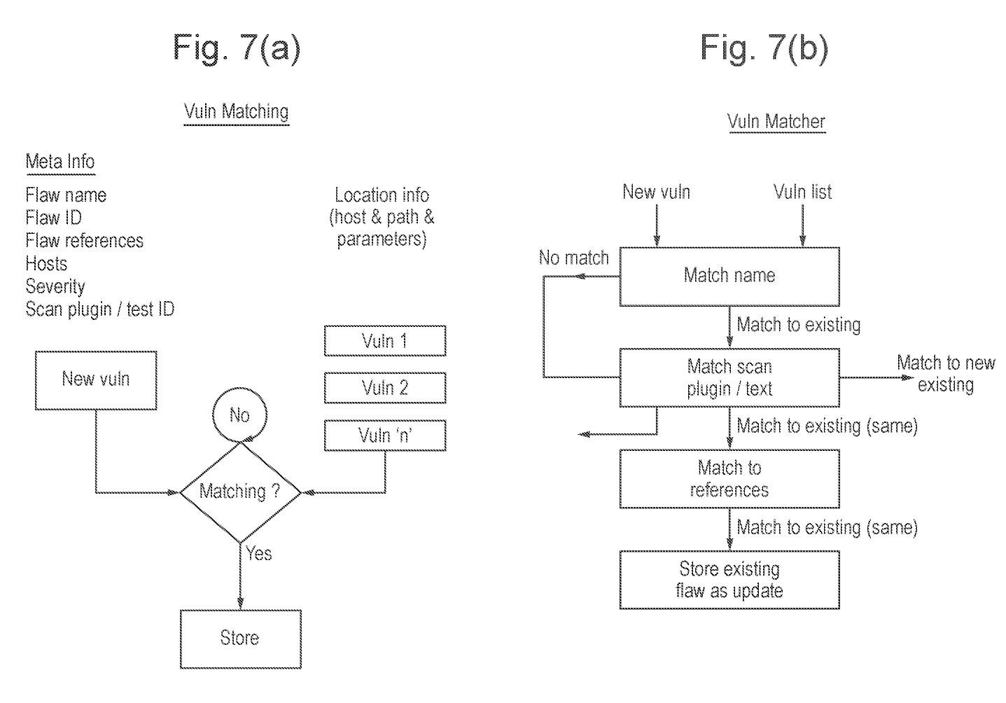

FIG. 7 shows the vulnerability matching process;

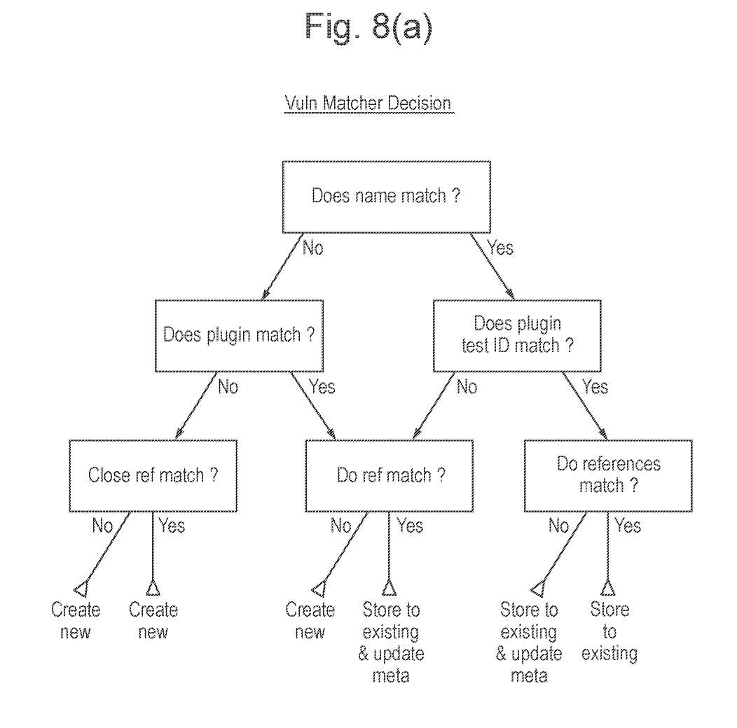

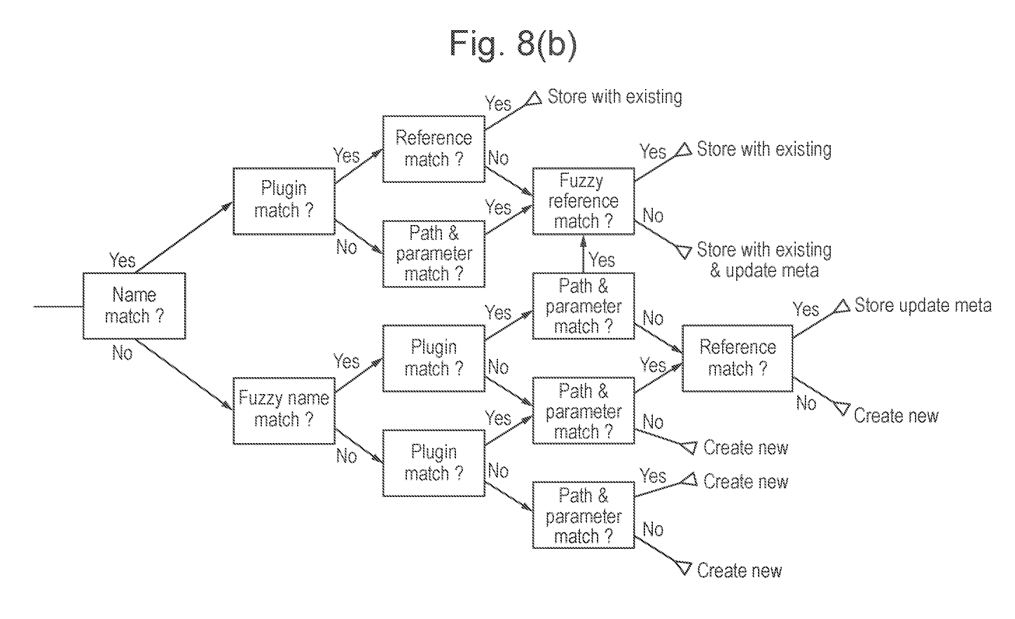

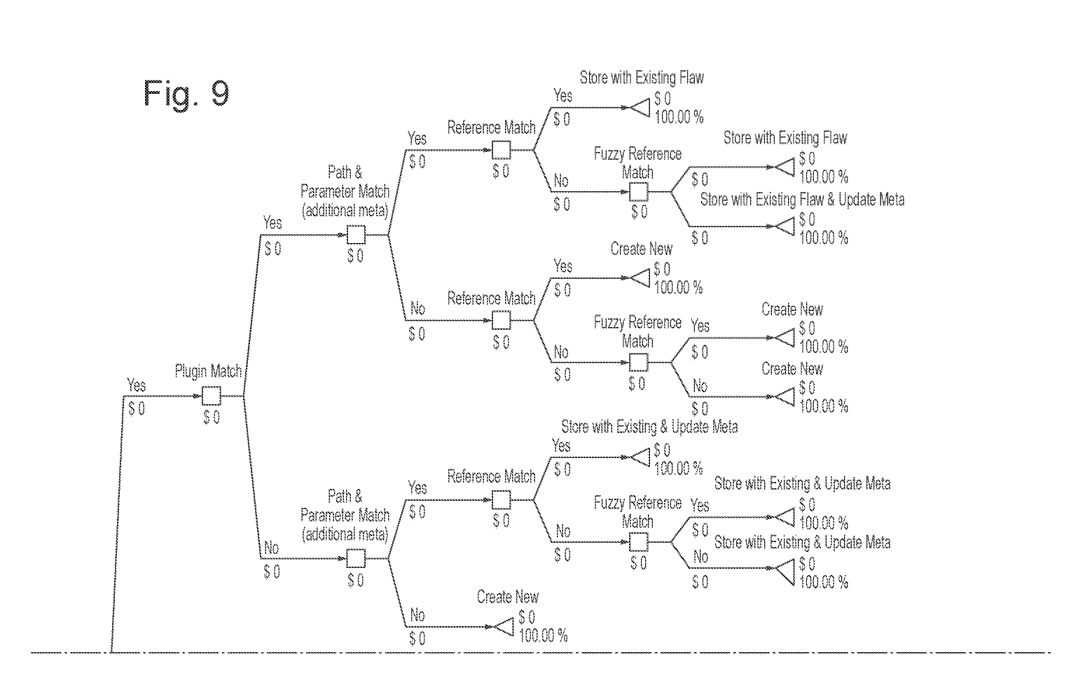

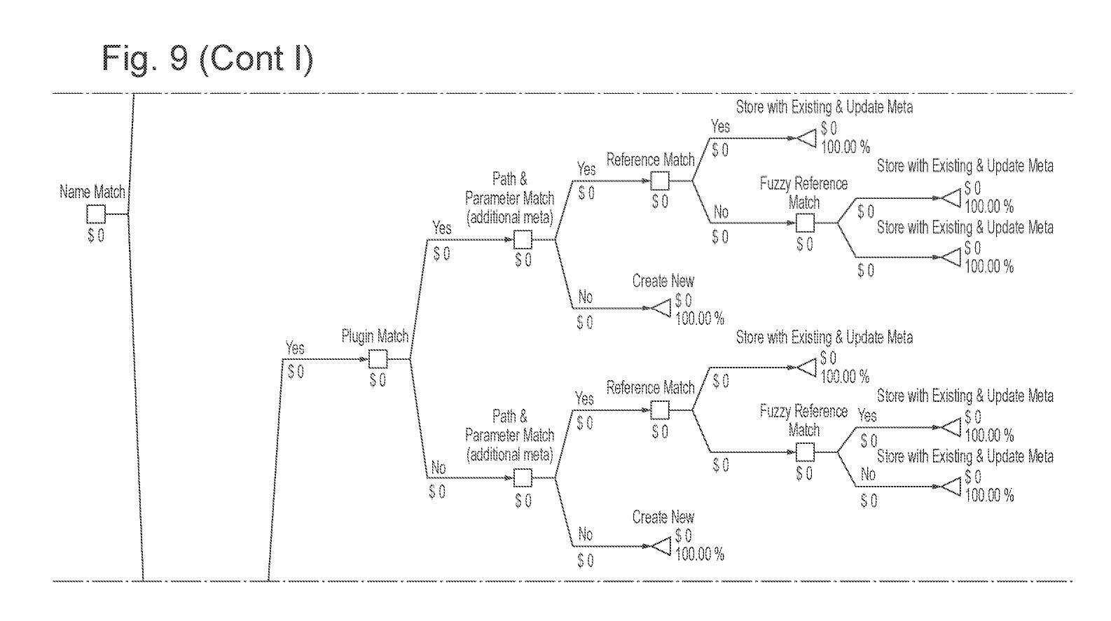

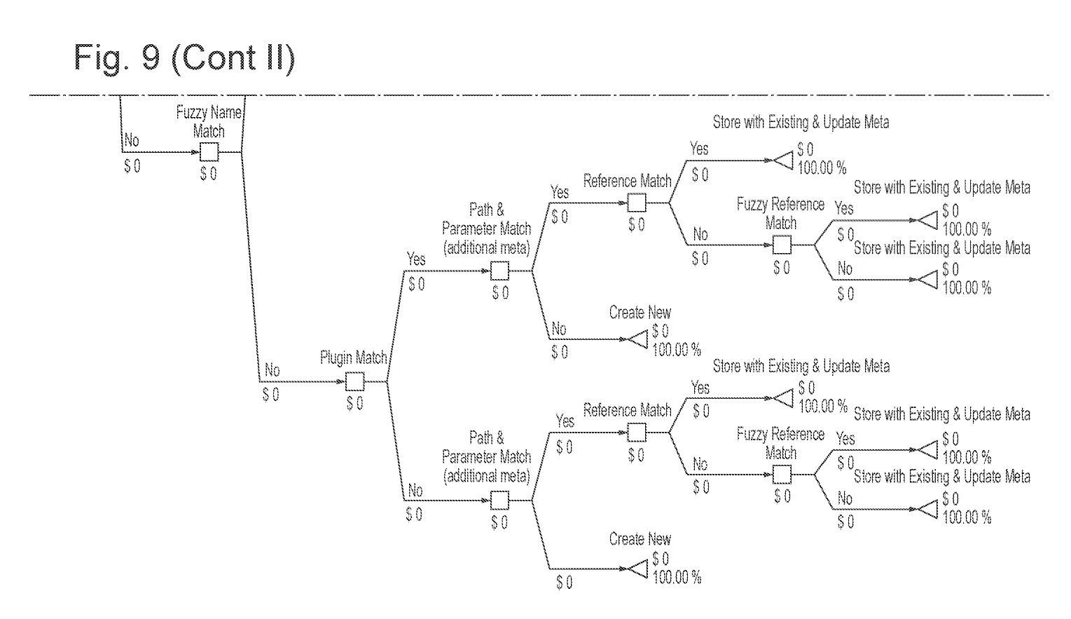

FIGS. 8 and 9 show examples of vulnerability matching decision trees;

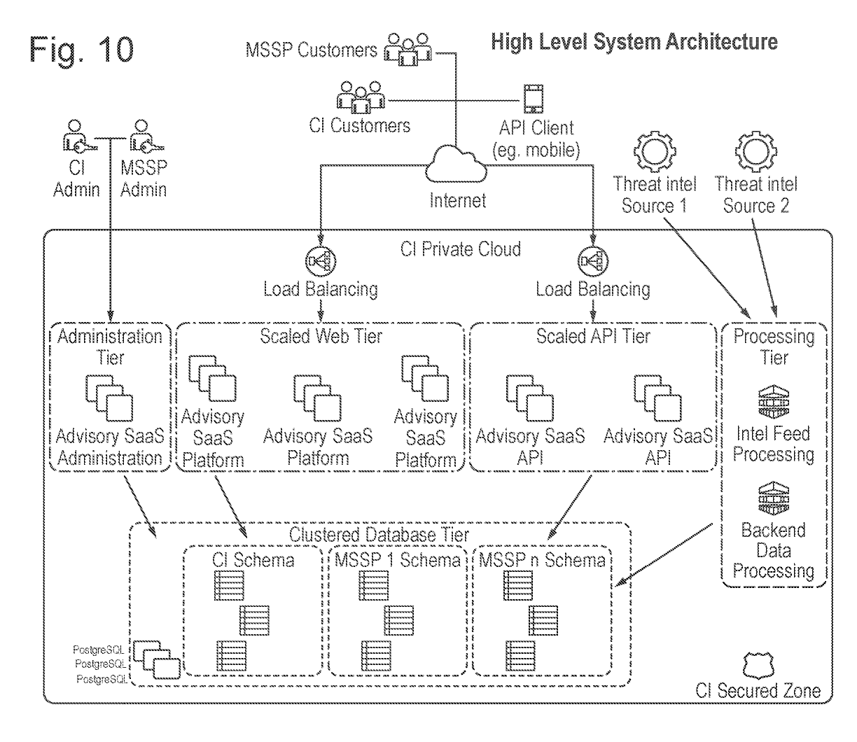

FIG. 10 shows typical high-level system architecture for the computer system;

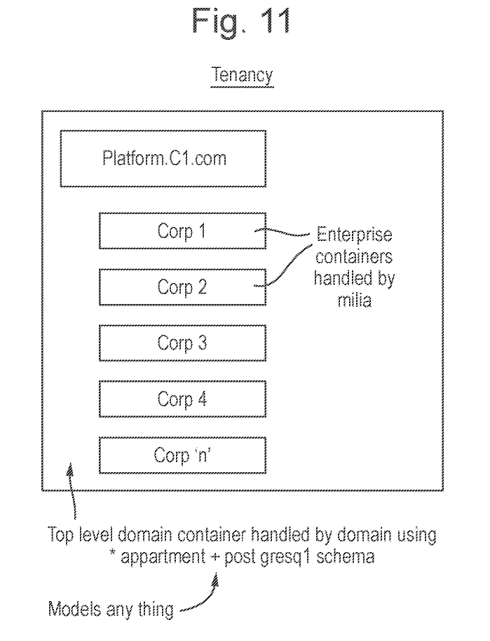

FIG. 11 shows details of the tenancy architecture; and

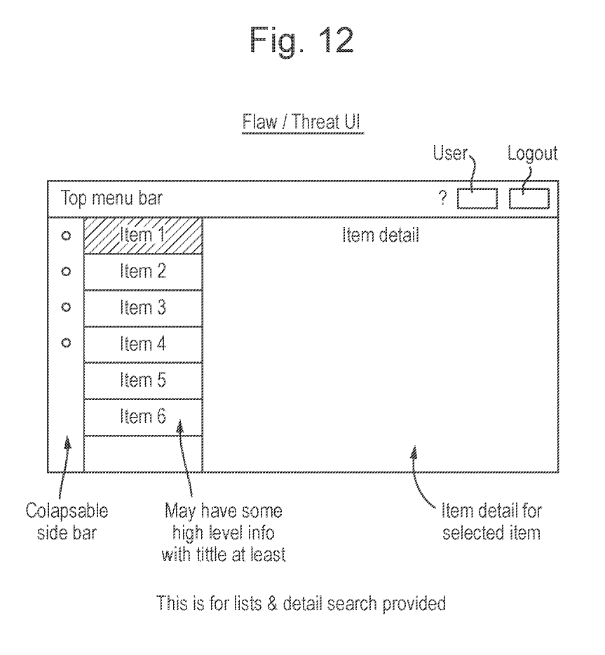

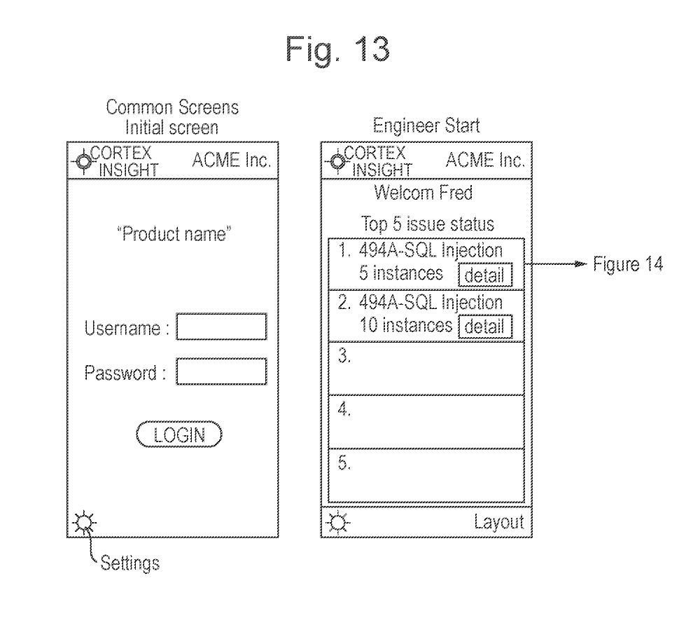

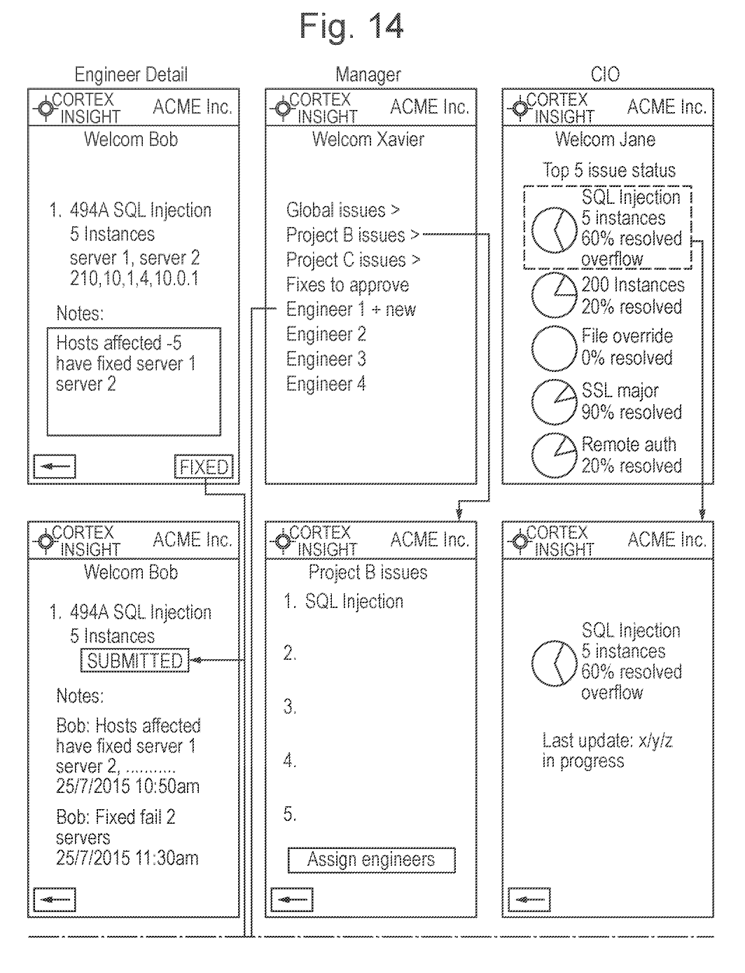

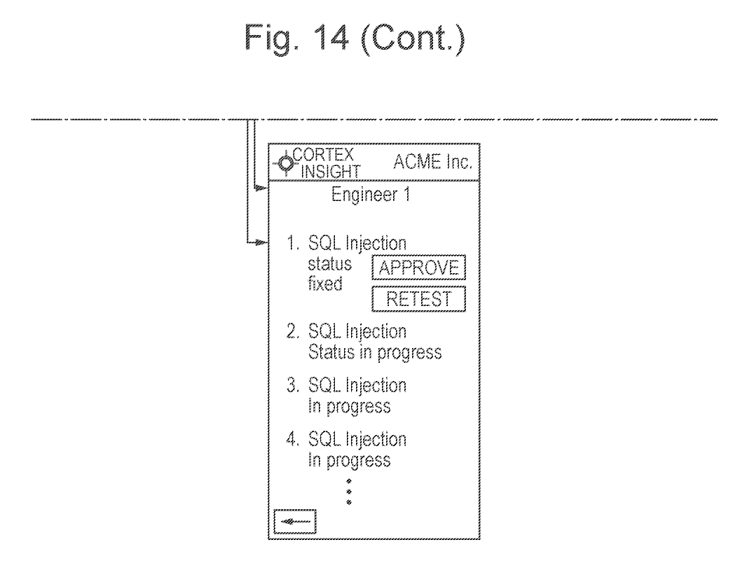

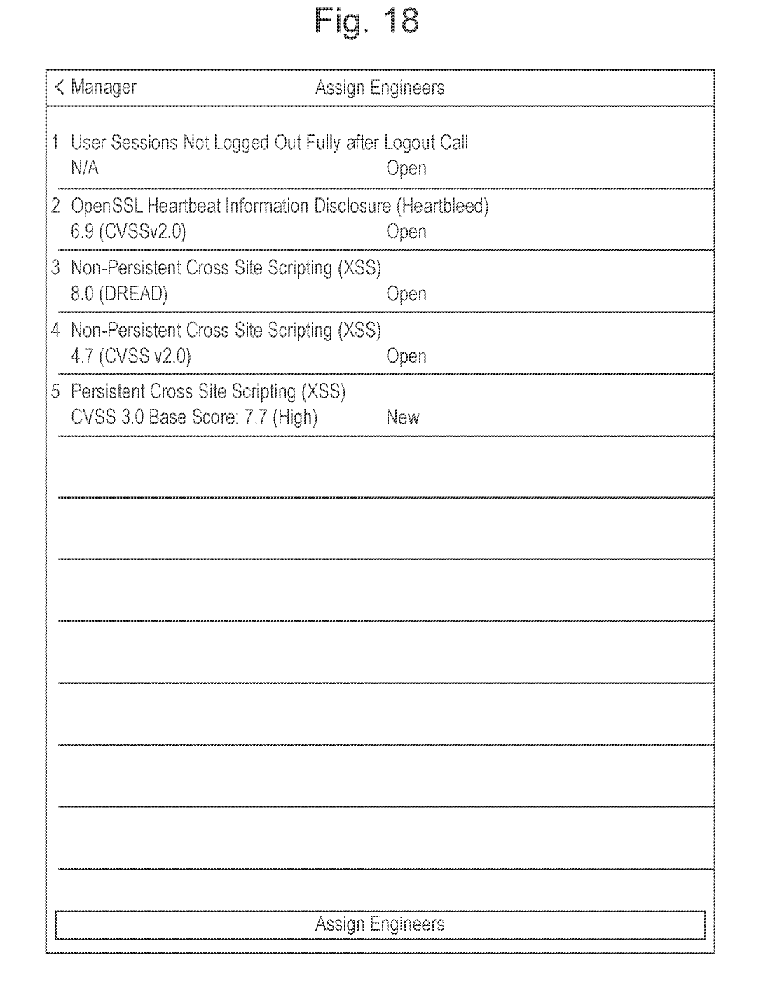

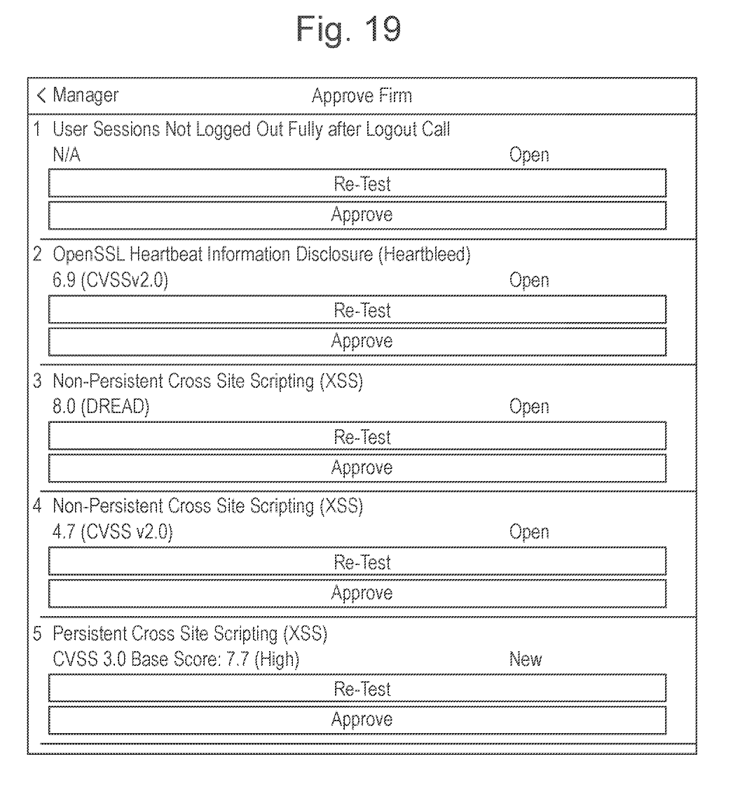

FIGS. 12-21 show aspects of the user interface, including:

FIG. 12 shows an example of the flaw/threat user interface;

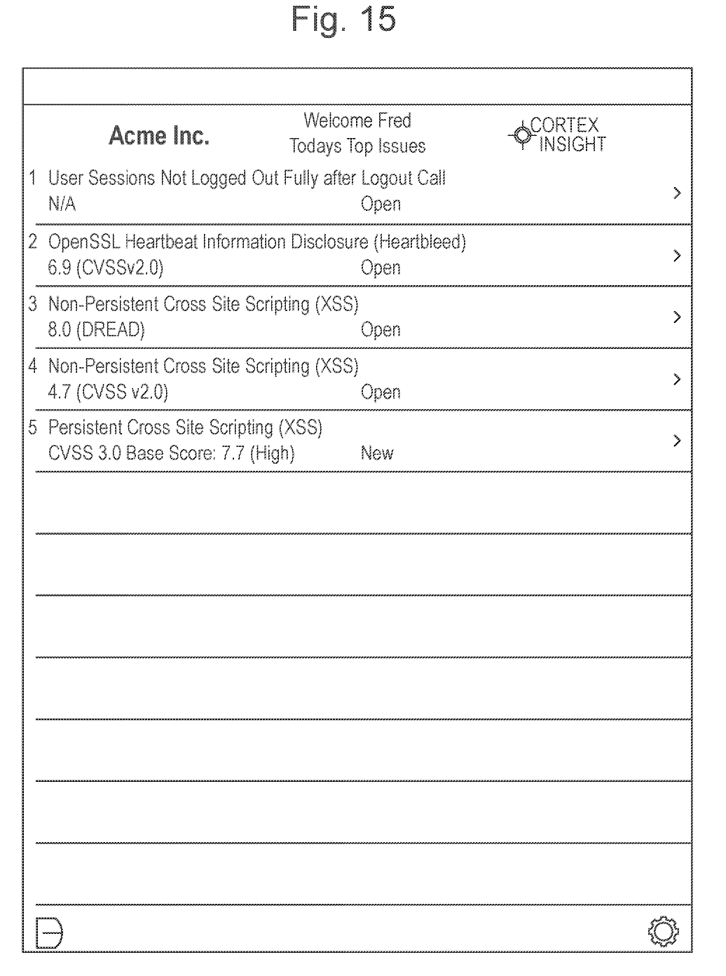

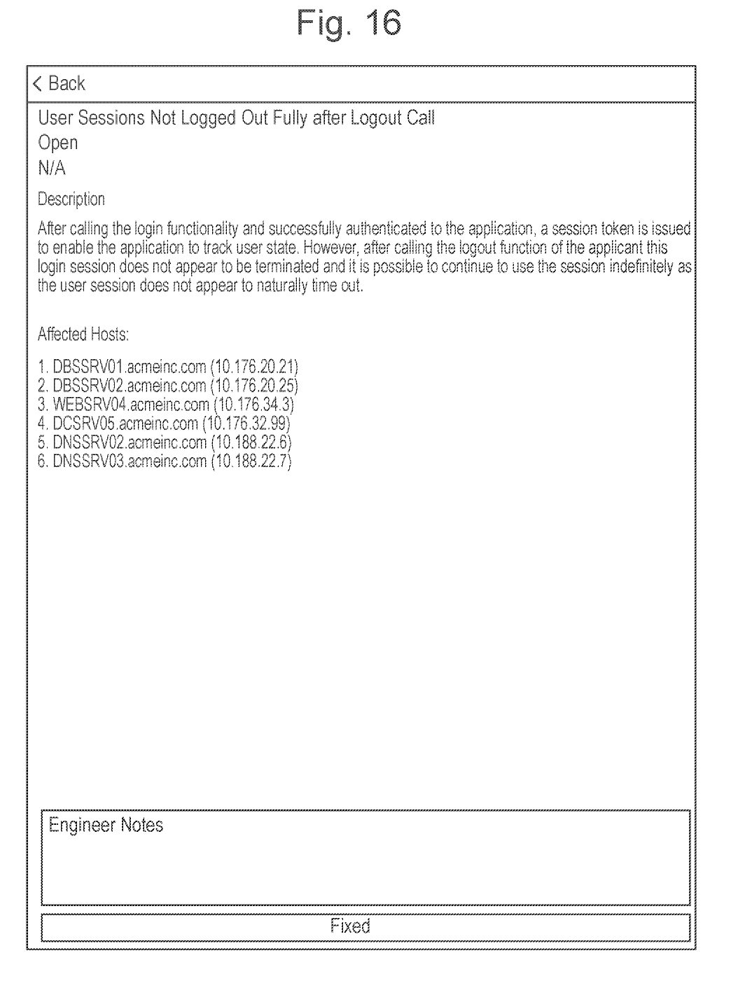

FIGS. 15 and 16 show an example Engineer view;

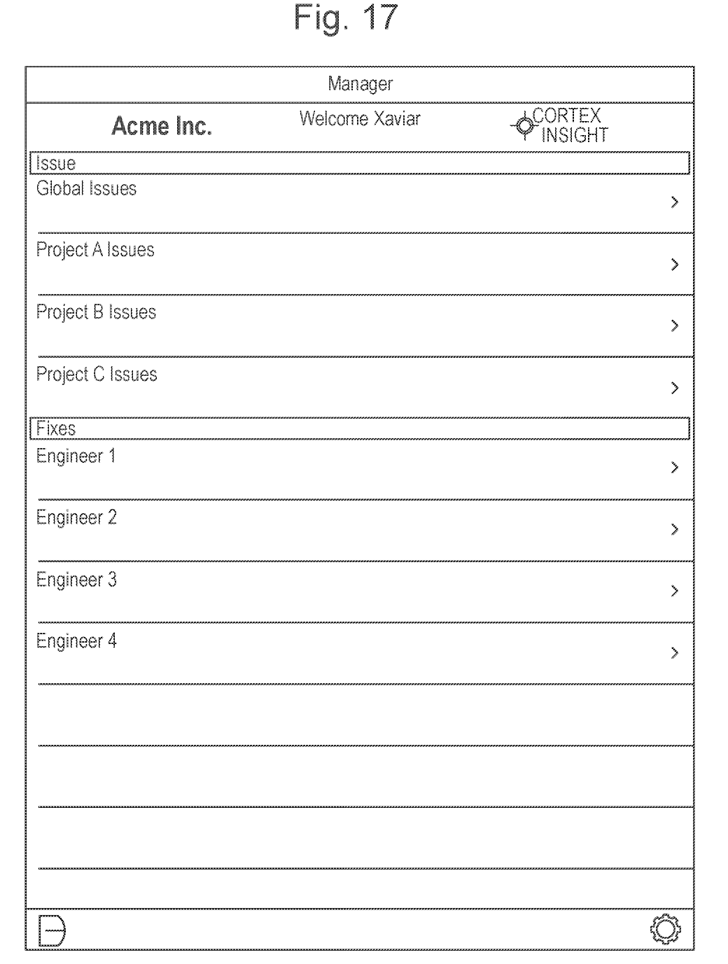

FIGS. 17, 18 and 19 show an example Manager view;

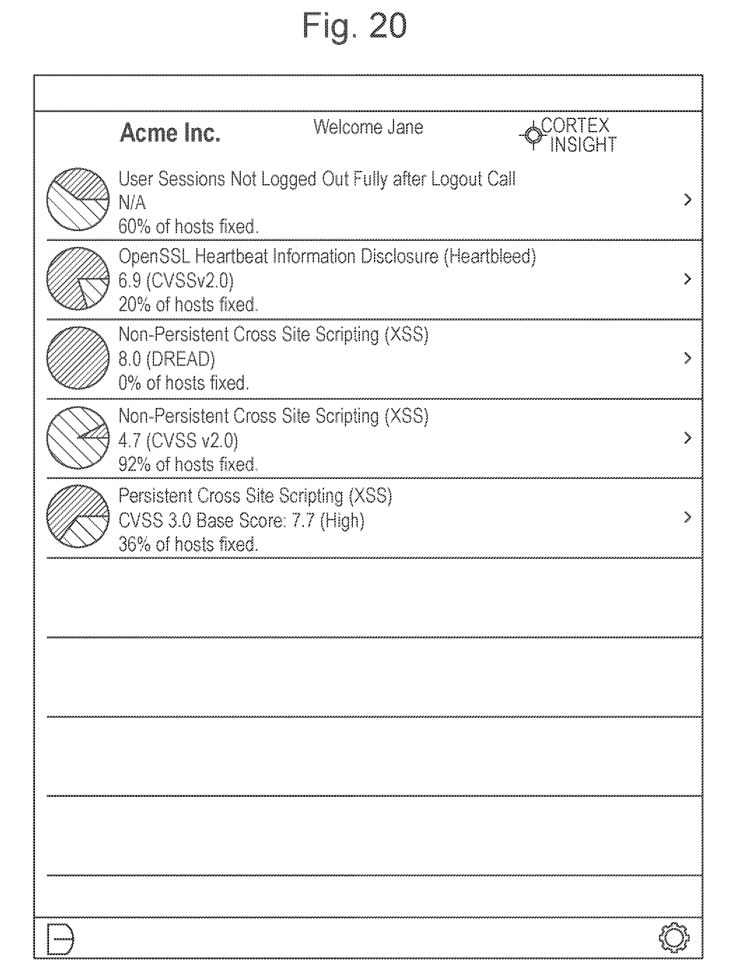

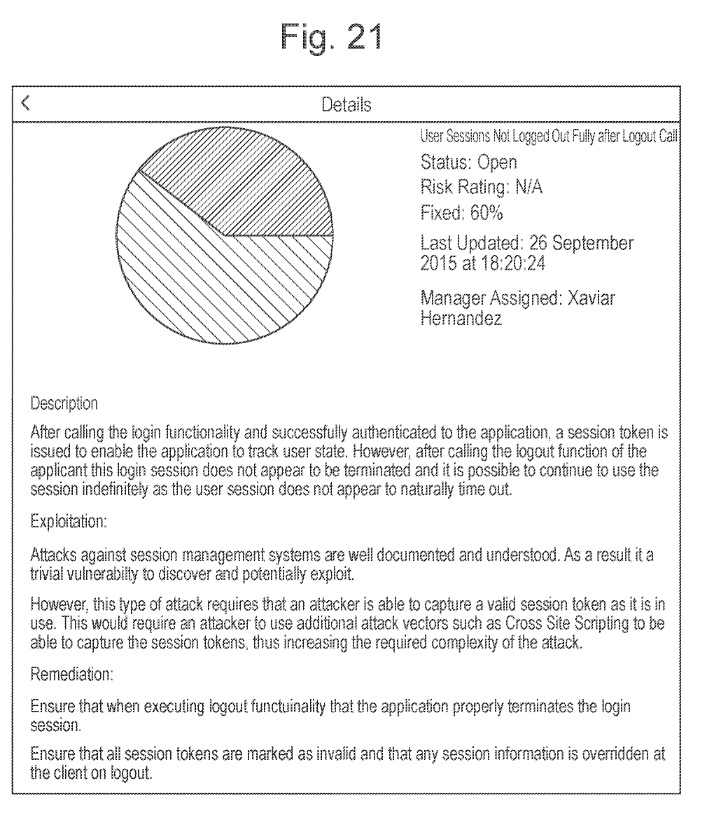

FIGS. 20 and 21 show an example CIO view; and

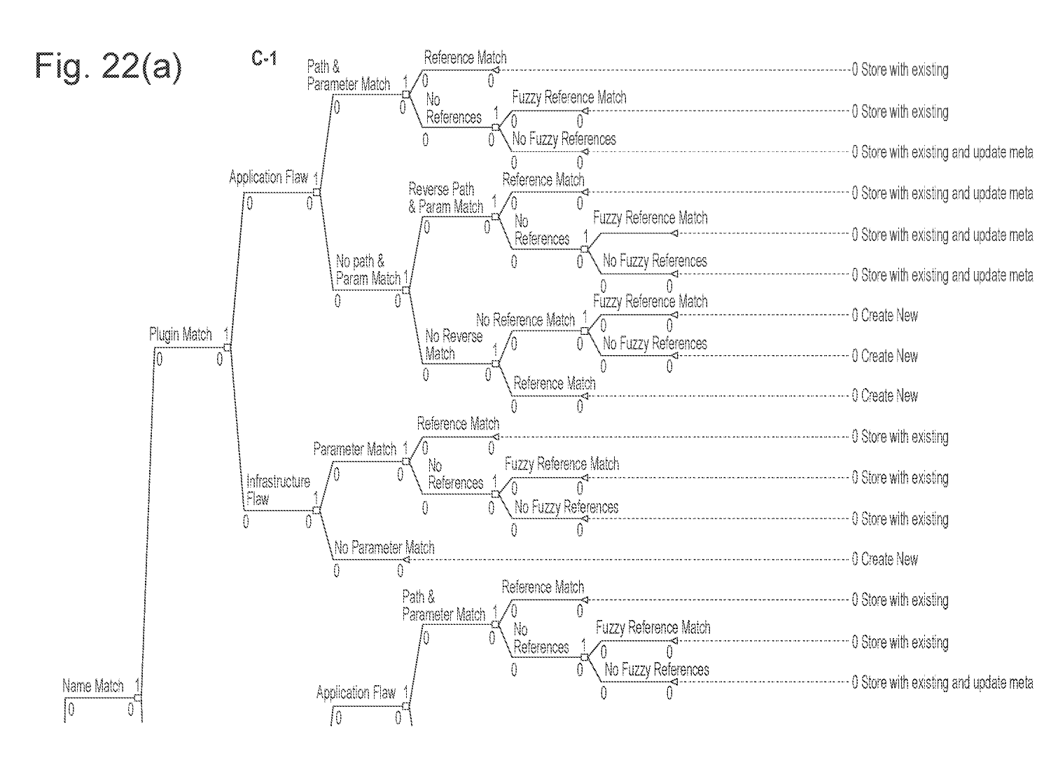

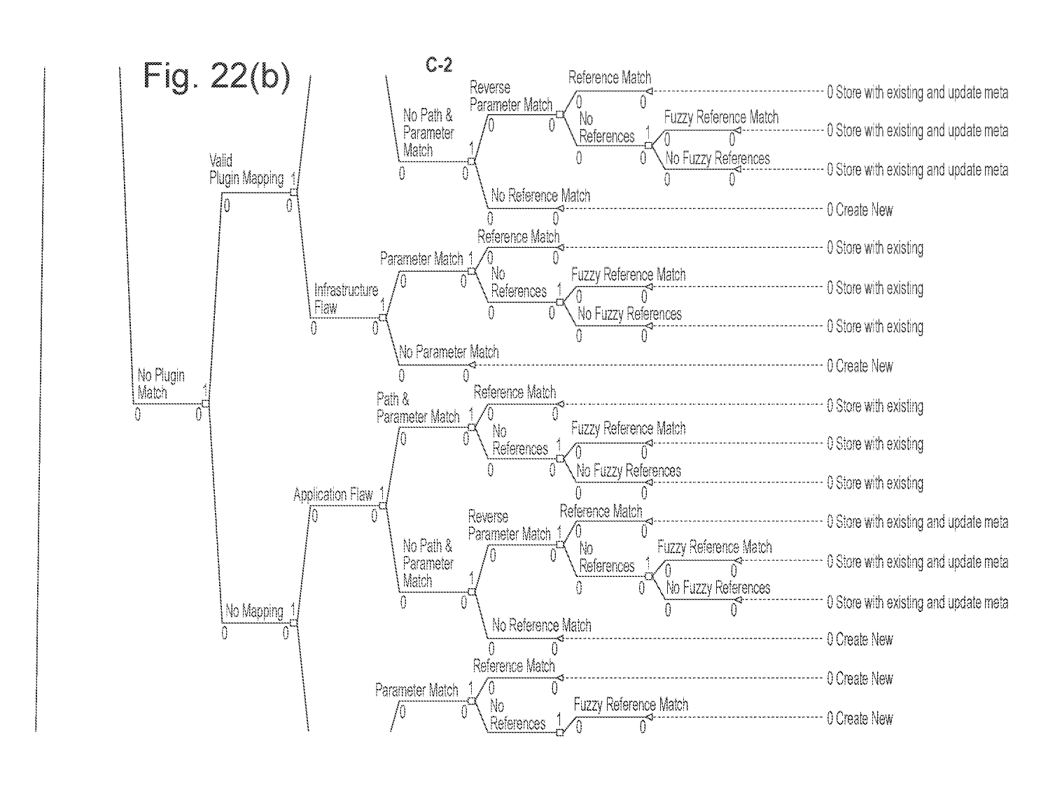

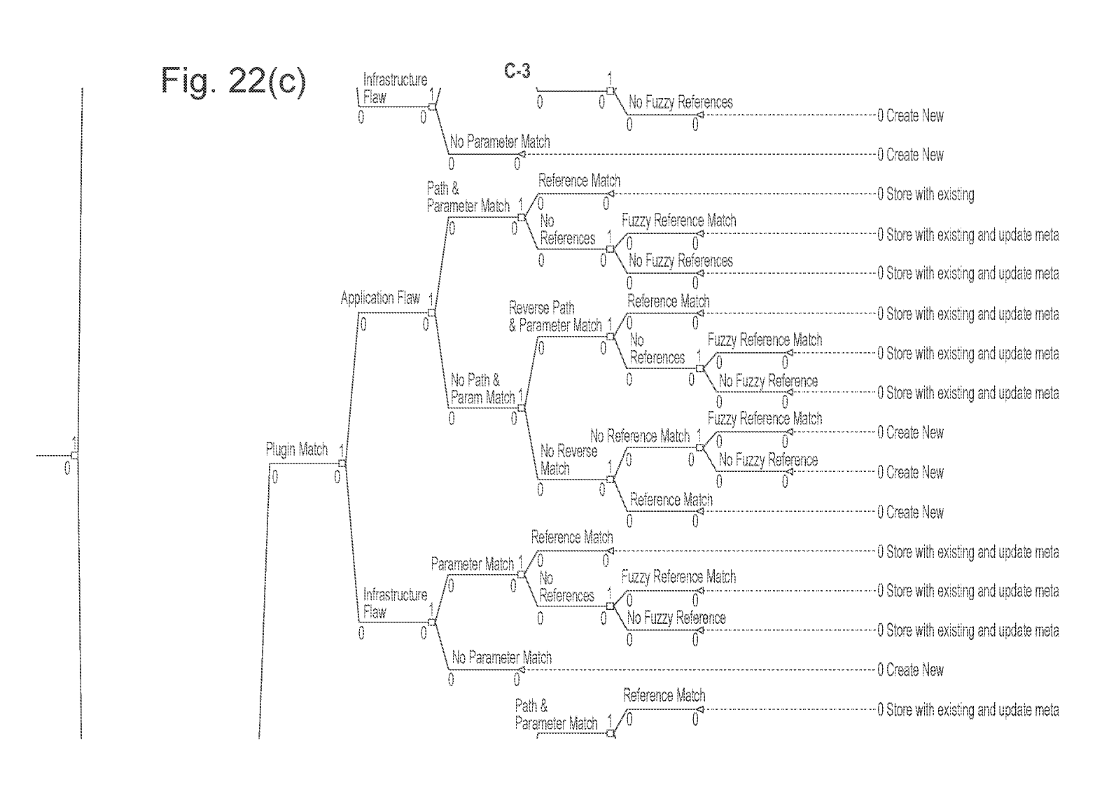

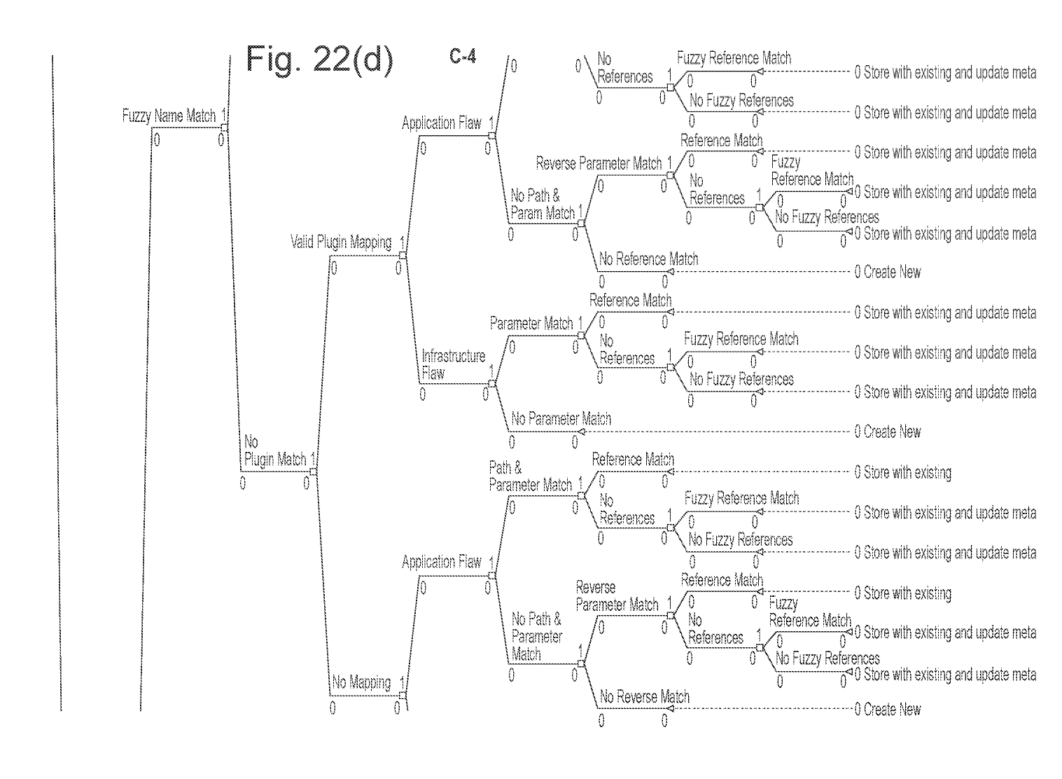

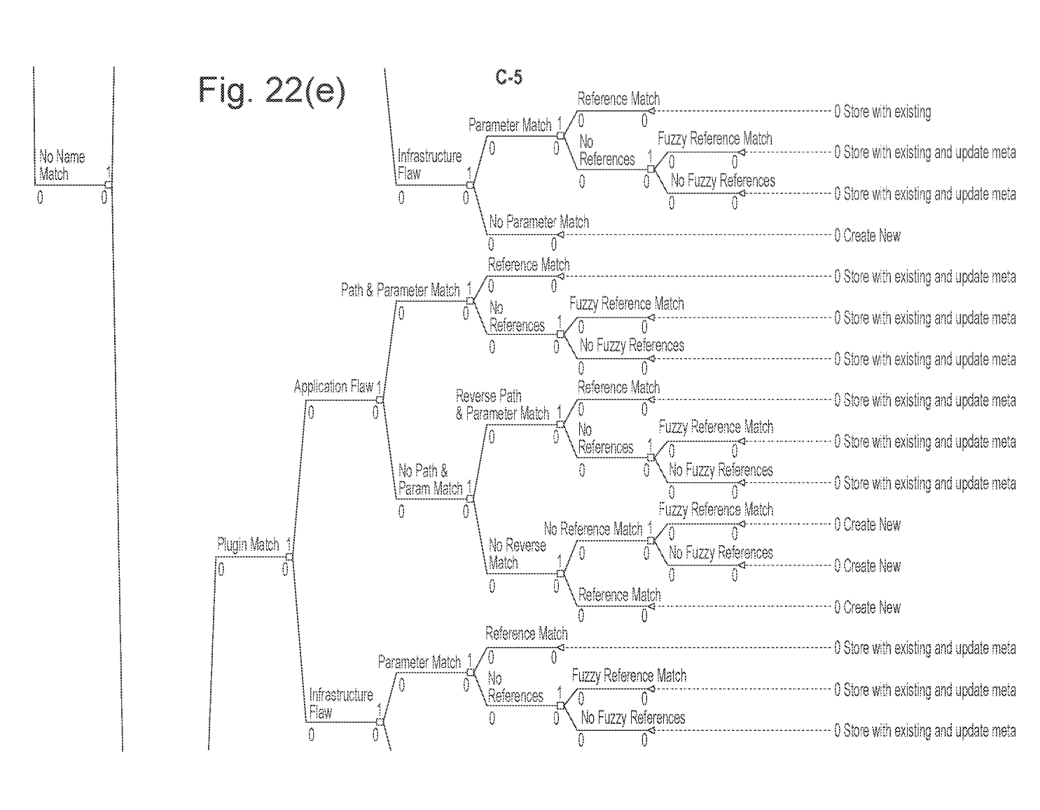

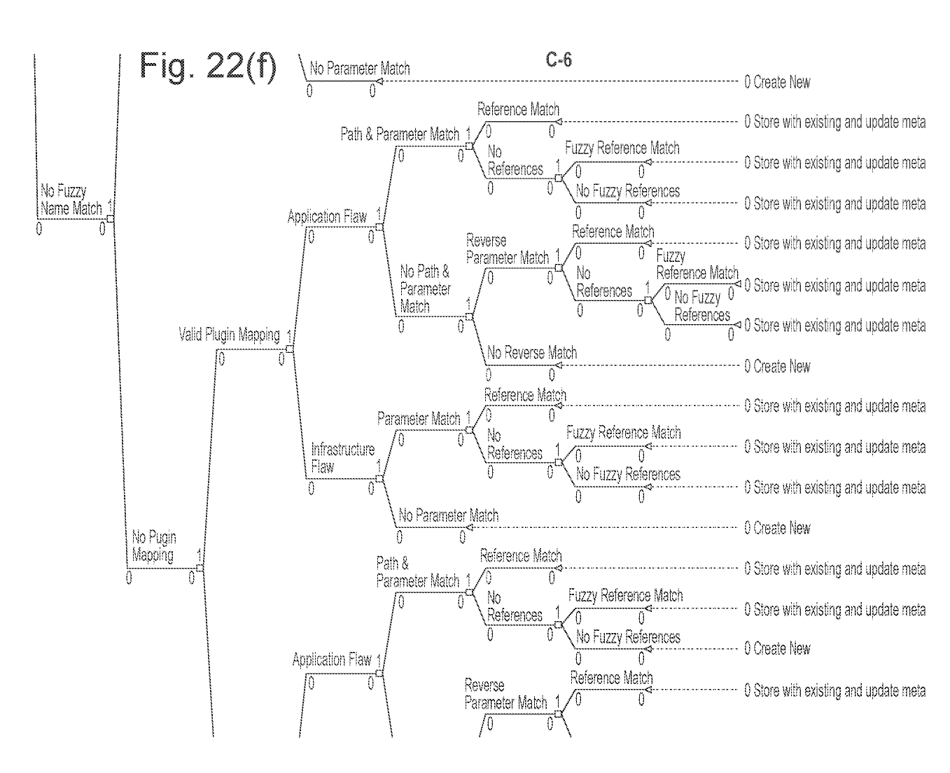

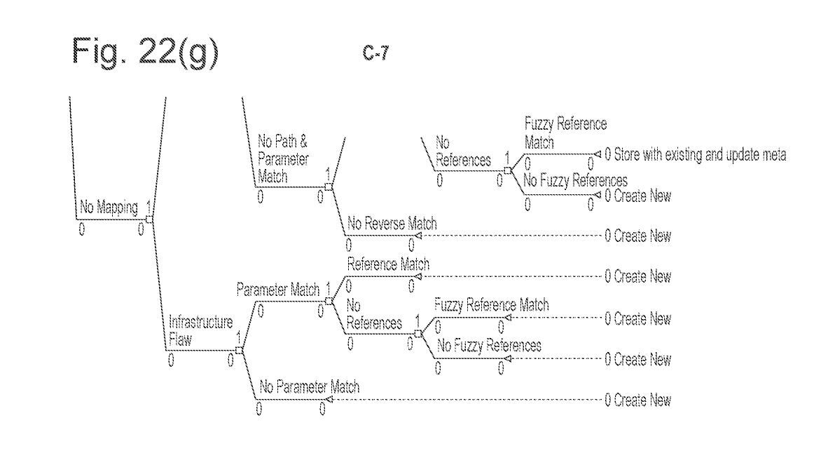

FIG. 22 shows a further example of a vulnerability matching decision tree.

### OVERVIEW

FIG. 1 shows a computer security system 10, comprising three main components:
threat modelling engine 20—which on the basis of data relating to an organisation generates a threat model for the organisation which is used to provide context to the vulnerabilities, outputting this as data feed #1
mapping engine 30—which on the basis of data feed #1 and information regarding known vulnerabilities identifies those specific vulnerabilities of potential threat to the security of the organisation, outputting this as data feed #3
prioritisation engine 40—which on the basis of data feed #3 ranks the specific vulnerabilities identified by the mapping engine 30 an ordered ‘remediation’ list 50 of vulnerabilities specific to the organisation and ranked in order of threat level to the organisation, outputting this as data feed #4.

Typically, an organisation would have a master or overriding threat model for the organisation as a whole, comprising a plurality of individual threat models one for each constituent computer system. The system as described can be applied to either circumstance.

FIG. 2 shows another embodiment of the computer security system 10, showing in further detail:
threat modelling engine 20—which receives multiple data feeds 22, 23, 24, 25, 26, relating to an organisation—for example, information regarding security requirements 22, use cases 23, business assets 24, external dependencies 25 and controls 26—and from these generates a threat model for the organisation which is used to provide context to the vulnerabilities, outputting as data feed #1
mapping engine 30—which receives a data feed 32 of known vulnerabilities and maps those to the threats identified by the threat modelling engine 20 to identify specific vulnerabilities of potential threat to the security of the organisation, outputting as data feed #3
prioritisation engine 40—which receives a data feed 42 of threat intelligence, for example identifying threats which have recently been (or are currently being) exploited at other organisations and uses this information to rank the specific vulnerabilities identified by the mapping engine 30, outputting as data feed #4

Also shown is an additional component:
vulnerability matching engine 60—which receives a data feed (more typically, multiple data feeds 62, for example details of flaws found via static 62-1/dynamic 62-2 scanning, manual testing 63-3 and configuration flaws 62-4) of vulnerabilities, categorises them according to threat type, and outputs a data feed 32 of known vulnerabilities to the mapping engine 30, outputting as data feed #2

Aspects of the threat-modelling, mapping and prioritisation engines—and of the vulnerability matching engine—are discussed in more detail below.

The output of the prioritisation engine 40 is an ordered list 50 of vulnerabilities specific to the organisation and ranked in order of threat level to the organisation, allowing them to be addressed according to priority. The list may be filtered, with vulnerabilities classified according to type, or re-ordered in dependence on additional data and/or user input. The vulnerabilities may also be presented graphically at a user interface. This may allow resources to be deployed to address the identified vulnerabilities and monitor the progress made in addressing them.

Generally, computer security system 10 is implemented as executable computer code, for example, as code developed on a web framework such as Ruby on Rails, running on a UNIX-based server with PostgreSQL as a database server and Apache as a web server. More details of an example implementation are provided below.

Threat Modelling Engine

FIG. 3 shows the data feed inputs and output of threat modelling engine 20.

The inputs comprise one or more data feeds (typically provided as text data) relating to the organisation, for example:
security requirements 22—these may comprise regulatory requirements, for example relating to health data (Health Insurance Portability and Accountability Act or HIPAA) or financial data (Sarbanes-Oxley Act or SOX), gambling regulations. The wording is usually precise and specific.
use cases 23—these are functional requirements, typically defined at the planning stage of an IT system, describing the user experience and interactions with the system. The wording is usually descriptive and non-standard.
business assets 24—these include details of the computer systems and computer-reliant systems of the organisation
external dependencies 25—these include threats arising from other threat models relating to other computer systems, whether inside or outside the organisation.
controls 26—these generally refer to mitigations arising from the particular use or configuration of a computer system of an organisation, often arising from a third party implementation that addresses (potentially inadvertently) a security issue which might otherwise arise from the system requirements, eg. the mandatory use of particular code or hardware that prevents certain vulnerabilities being exploited. A control may be implemented in software or as a physical process eg. the use of two-person split passwords or dual keys.

Threat modelling engine 20 parses these inputs and categorises the threats to allow vulnerabilities to be mapped to them by the mapping engine 30.

FIG. 4 shows the data flow in the threat modelling engine 20.

Generally, threats are determined from natural language processing of a plurality of data sources, including organisation and standards documentation, to identify either keywords which may be mapped to threats directly or concepts which depending on the security requirement(s) (SecReq) may be identified as relating to a threat.

Categorisation of threats is in accordance with a threat modelling tool or framework. Various industry-standard ones may be used, for example:
Microsoft's STRIDE—which mnemonic describes six categories: Spoofing identity, Tampering with data, Repudiation, Information disclosure, Denial of service, Elevation of privilege—each identified threat being assigned to one or more categories
OctoTrike—an open source threat modelling methodology
Process for Attack Simulation & Threat Analysis (PASTA)
Application Security Frame (ASF)
Open Web Application Security Project (OWASP)

In some embodiments a composite or bespoke framework is used.

Language Processing

As shown, in this example use cases 23 and security requirements (SecReq) 22 are fed into NLP engine 80 which identifies relevant keywords and concepts, typically by making use of classifier algorithms such as Bayesian or TF-IDF algorithms. Each has advantages and disadvantages—generally Bayes methods being more efficient, TF-IDF being more specific. Other methods of classification may also be used, for example Recurrent Neural Network model or Support Vector Machines (SVMs) such as SVM Torch and SVM Light.

In some embodiments a hybrid classifier comprising at least two different algorithmic classifiers is used, either sequentially, for example using the output of Bayes to seed TF-IDF, or in parallel, comparing the outputs and making use of the one with the highest confidence score.

Threat Classification/Categorisation

Once a security threat is identified it is classified/categorised 82 according to the appropriate threat modelling tool or framework.

Classification of threats (assigning each an appropriate threat mnemonic) is optimised with training data.

FIG. 5 shows threat classifier of the threat modelling engine in training mode. The accuracy of the classifier improves as it processes more data—and receives feedback on its classifications. In this example, the classifier divides use cases 23 into two categories:
security threats (use cases 23-1, 23-3 and 23-5)
non-security threats (use cases 23-2, 23-4 and 23-6)

Threat Selection

The classified/categorised threats 82 then undergo selection 84 to produce an organisation-specific threat list 85.

Selection may be based on a classifier or be rules-based, eg.
? if source is ‘x’ and target is ‘y’
? if external source is ‘x’ and target is ‘y’
? if external target is ‘y’ and source is ‘x’
if ‘technology’==‘x’
if ‘authentication’ ?

Further filtering may be based on language.

Threat selection may also result from the interplay between the various inputs into the threat modelling engine 20. For example, a use case 23 may directly address and mitigate a threat arising from a certain security requirement 22.

Also, individual threats may have a dependency on other threats, whether within the same threat model or arising from an external threat model.

Selection may result from the application of other relevant information, for example knowledge from a dedicated threat knowledge base or database (see FIG. 4b) or in dependence on some other factor such as timeliness (some threats, such as scripting attacks, are highly time-of-day dependent).

FIG. 6 shows an example filter flowchart for determining a threat list in dependence on use cases, converting the classifier-based list to a qualified list.

Manual Review

A further threat selection may be performed manually.

The organisation-specific threat list 85 is presented via a user-interface to the user (typically a security professional or system administrator) of the security system 10 for manual review 86, approval and/or further input of threat data 87.

Manual review of the (qualified) threat list, for example via approve/disapprove checkboxes or similar selection mechanism, provides for a ‘sanity check’ by the user of the threat list.

Some embodiments also provide for threat details to be entered manually 87 and for existing threat risk ratings to be adjusted. If a user does not agree with the use case or SecReq mapping they can re-adjust it, and the readjustment will be fed back to retrain the decision engine, ie. manually entered threats are linked to Use Cases or SecReq and then added to the training data.

Controls 26 may be manually linked to/unlinked from threats. Controls that exist or are recommended may be identified as relevant.

The output is an approved organisation-specific threat list 88. The list is as yet unordered (as no risk weightings have yet been determined), with duplicates (unless manually entered) having been removed or merged.

Risk Generator

The threats identified in the approved organisation-specific threat list 88 are then (initially) rated 90 for risk.

Controls and the Control Filter

The effect of controls 26 is taken account of 92, resulting in a modified risk rating.

Output from the Threat Modelling Engine

Output from Threat Model (#1):
Threat List
   Risk rating for threat (raw and modified)
   Controls and mitigations
   Threat source
   is then passed to the mapping engine 30.

Matching Engine

Matching engine 60 maintains the database of vulnerabilities used by the mapping engine 30. In particular, it ensures that each flaw or vulnerability is uniquely identified in the database.

Scanning tools as used in the computer security industry often generate large amounts of data. Users also typically run multiple scanning tools on their computer systems to increase security. Each tool typically generates a report file which includes details of the flaws or vulnerabilities found including name or identifier, source, path etc.

However, there is little consistency in identifiers (for example, different names, prefixes and sundry punctuation). Industry standard identifiers (eg. references to Mitre CWE or CVE lists) are used along with ad hoc references.

Matching engine 60 accepts reports from multiple scanning tools (whether static, dynamic or annual), parses the reports and uses a decision tree method to match the associated metadata against existing entries in the vulnerability database, either storing the vulnerability data as a new record or updating/merging with an existing record as appropriate.

FIG. 7 shows the vulnerability matching process.

FIGS. 8 and 9 show examples of vulnerability matching decision trees.

Fuzzy matching (see the lower branch of FIG. 8(b) and FIG. 9) may also be employed, either initially or at later stages in the matching process. For example, when despite initial matches at early stages of traversing the decision tree a threshold number of subsequent metadata matches fail, the process may switch to the ‘fuzzy’ branch to seek an alternative closer match. Also, progress along a particular ‘branch’ may be curtailed when it becomes clear what the eventual match is likely to be.

FIG. 22 shows a further example of a vulnerability matching decision tree.

Matching may also be made in dependence on flaw type, eg. distinguishing between infrastructure and application flaws.

A plug-in equivalency check may also be made.

Examples of data points for the vulnerability/flaw-matching algorithm include:
Flaw Name
Fuzzy Flaw Name (Fuzzy match using simhash and Dice's Coefficient (aka Pair Distance) algorithms)
Plugin Match
Plugin Equivalence Match
References Match
Fuzzy References Match
Flaw Type
Application Flaws—Path and Parameter Match
Infrastructure Flaws—Port, Service and Protocol Match
Meta Information Fingerprint Match
Reverse Path and Parameter Match
Flaw Description/Detail Analysis
Flaw artefact analysis

Optionally, where a scanning tool provides a risk rating this may also be imported. Preferably, this is only done for standard risk ratings (risk ratings may also be provided by penetration testers). Hence an entry in the database for vulnerability from a first scanning tool and initially without a standard risk rating may be updated when the record is merged with new data on the vulnerability provided by a second scanning tool which does provide a (standard) risk rating for the vulnerability.

Where no risk rating is provided one is assigned.

In some embodiments, non-standard risk ratings are translated to a common or standard rating.

Output from the Matching Engine

Output from Matching Engine (#2)
Vulnerability List (flaws)
   Ordered, consolidated, categories
   Risk rating for flaws/vulnerabilities

Mapping Engine

Mapping engine 30 receives the threat list (output #1) from threat modelling engine 20 and the vulnerability list (output #2) from matching engine 60 and maps one to the other, ie. categorising vulnerabilities according to threat type—optionally to an individual threat—and assigning a (initial) risk rating.

Mapping engine 30 uses NLP and/or known direct mappings to pair vulnerabilities with threats. NLP methods as described previously identified may also be used to perform classification/categorisation of vulnerability/threat.

In some embodiments, mapping engine 30 also performs mapping of vulnerabilities that can be linked into a ‘vulnerability chain’, ie. vulnerabilities that when combined may make a threat viable which each vulnerability in isolation would not. Each threat has an associated list of vulnerability types and chains that make the threat viable.

Typically, the output is a filtered table, comprising hundreds of threats.

Output from the Mapping Engine

Output from Mapping Engine (#3)
Combined Threat and Vulnerability/Flaw List
   Vulnerabilities/flaws are mapped to threat
   Vulnerabilities/flaws linked to controls
   Vulnerability/flaw chains
   Vulnerability/flaw chains mapped to threat

Prioritisation Engine

Prioritisation engine 40 receives the combined threat and vulnerability/flaw list from the mapping engine 30 and orders it by risk based on a risk rating, preferably also making use of (ideally, real-time) threat intelligence. This allows for risks to be assessed and assigned priorities, determining which vulnerabilities need to be fixed first.

A scanning tool might rate different vulnerabilities the same, whereas in practice for a particular organisation the actual risk may be higher—or lower.

For example, regulatory requirements may raise/lower the risk rating of certain threats. Some vulnerabilities may not have an associated threat and are may therefore be considered less significant. Some threats may be time-dependent.

Threats may be risk-rated according to standard schemes, typically DREAD, which rates of threats according to five categories: Damage potential, Reproducibility, Exploitability, Affected users, Discoverability. Other risk rating systems such as CVSS and OWASP may also be used. Alternatively, a composite or bespoke scheme is used.

Consideration is made of interactions between threats. Often, interactions between threats mean that several low-level threats potentially form a more serious composite threat. This may address the issue of vertical or ‘silo’ thinking commonly found in computer security, often a reaction to the volume of security vulnerability data generated.

Consideration is made of interactions between threats and vulnerabilities and mitigations recorded within the system. Mitigations detail the controls or features employed to reduce or eliminate risk of a threat or vulnerability. Threats or vulnerabilities which are wholly mitigated will have their risk reduced accordingly and are recorded in the output as ‘mitigated’. Those with remaining residual risk after mitigation will have their risk rating adjusted and are recorded in the output as ‘partially mitigated’.

A similar consideration is made regarding interactions with vulnerabilities and/or threats arising from other threat models as applied to other computer systems in—or external to—the organisation.

Typically, the output of prioritisation engine 40 comprises—for each relevant threat—two risk rating elements: the ‘raw’ risk rating, as initially provided by a scanning tool and a (threat) ‘modified’ risk rating (0-10). Where provided, the ‘raw’ risk rating is user modified before being threat modified.

The prioritisation engine 40 will adjust the risk rating based on Threat Intelligence elements of the risk rating assigned to the threat or vulnerability to raise awareness of an active threat actor. Where available within the risk rating methodology aspects relating to the threat actor will be used to indicate the seriousness of the threat actor.

Examples of risk ratings and consideration follow below:

Cortex Insight/Core Risk Rating

An overall risk or severity rating may be defined, comprising:
Technical Impact rating 0-10
Business Impact rating 0-10
Threat Agent rating 0-10
Vulnerability Exposure rating 0-10
where a typical scale for each is:

| | |
|---|---|
| 0 | Informational |
| 1-3.9 | Low |
| 4-5.9 | Medium |
| 6-8.9 | High |
| 9-10 | Critical |

The resulting overall rating is given by:

Base Rating=(Technical Impact+Business Impact+Vulnerability Exposure)/3

However there is a modified score based on the threat agent, this is calculated as follows:

Threat Modified Rating=(Base Rating+Threat Agent Score)/2

Impact Rating

An impact rating may comprise Technical and Business aspects.

Technical Impact Rating

Comprising individual ratings for confidentiality, integrity, availability and accountability.

Tc- Confidentiality
Data compromise exposure. How much sensitive data is exposed.

| | |
|---|---|
| 0 | None |
| 2 | Minimal, non-sensitive data |
| 5 | Extensive, non-sensitive data |
| 6 | Minimal, sensitive data |
| 7.5 | Extensive, sensitive |
| 10 | Total breach/All data |

Ti-Integrity
How much data could be at risk to corruption or loss

| | |
|---|---|
| 0 | None |
| 1 | Minimal (1%) corruption |
| 3 | 10% loss/corruption |
| 5 | 55% loss/corruption |
| 7 | Extensive (75%) loss/corruption |
| 10 | Total loss |

Ta-Availability
Service interruption

| | |
|---|---|
| 0 | None |
| 1 | Minimal, secondary services |
| 5 | Minimal, primary services |
| 5 | Extensive secondary |
| 7.5 | Extensive primary |
| 10 | Total loss, major interruption to |
| | services before recovery (days) |

Tr-Accountability and Non-repudiation
The ability to connect to an individual

| | |
|---|---|
| 1 | Fully traceable |
| 6/7 | Partially traceable |
| 10 | Fully anonymous |

where, for example:

Technical Impact=(Tc+Ti+Ta+Tr)/4

Business Impact Rating

Bc-Financial cost
How much would a successful exploit cost

| | |
|---|---|
| 1 | Less than cost to fix |
| 3 | |
| 5 | |
| 7.5 | Significant effect on profit (>50%) |
| 10 | Bankruptcy |

Bd-Reputational or Brand Damage
Would an exploit result in brand damage

| | |
|---|---|
| 1 | Little or no discernible damage |
| 5 | Damage to either brand or reputation |
| 10 | Significant damage to both brand and |
| | reputation |

Br-Regulatory non-compliance
Would failure to fix result in non-compliance

| | |
|---|---|
| 0 | Non-violation |
| 2 | Minor violation |
| 4 | Clear violation (industry non-standard) |
| 6 | Clear violation (statutory regulation) |
| 8 | High profile civil sanctions |
| 10 | Negligence resulting in criminal sanctions |

Bu-Affected users
How many users both internal and external would the flaw affect

| | |
|---|---|
| 0 | None |
| 3 | One individual |
| 5 | Hundreds of users |
| 7 | Thousands of users |
| 9 | Millions of users |
| 10 | All users |

where, for example:

Business Impact=(Bc+Br+Bb+Bu)/4

Threat Rating

Consideration may also be given to the nature of the threat, for example:

As-Skill level
Skill or tech of attacker

| | |
|---|---|
| 0 | None |
| 3 | Skilled at using tools developed elsewhere |
| 5 | Semi-skilled |
| 7.5 | Skill in one discipline, able to develop tools to |
| | support |
| 10 | Highly skilled/multiple penetration disciplines |

Am-Motive (only used by intelligence source)
Threat source motivation

| | |
|---|---|
| 1 | Little/low or no reward |
| 5 | Possible reward |
| 10 | High reward |

Ar-Threat agent resources
What resources are required and are available to the threat agent

| | |
|---|---|
| 1 | Limited or no resources available |
| 3 | Average resource levels |
| 5 | Resources available, either high levels of time, money and |
| | other resources (people, tools, equipment) |
| 7.5 | High levels of resources in two fields |
| 10 | Nation State Actor, unlimited time, money and resources |
| | available (people, tools, equipment) |

Az-Threat agent size
How large is the potential pool of attackers

| | |
|---|---|
| 2 | Developers/system admin |
| 4 | Internal users |
| 5 | Partners |
| 6 | Authenticated users |
| 10 | Anonymous internet users |

where for example:

Threat Agent Rating=(As+Am+Ar+Az)/4

Other Ratings

Examples include:
Vulnerability exposure:

Vd-Vulnerability Discovery
How easily identified is the issue

| | |
|---|---|
| 1 | Requires access to application code |
| | and system |
| 3 | Requires access to internal |
| | resources to determine behaviour, |
| | requires multiple forms of |
| | authentication/ |
| 5 | Requires monitoring for blind |
| | responses by system. Requires at |
| | least one layer of authentication to |
| | enact access |
| 7.5 | System behaviour responses highly |
| | indicative of vulnerability. Publically |
| | available system with one layer of |
| | authentication. |
| 10 | Can easily be determined using |
| | tools and knowledge based on |
| | system behaviour responses. |
| | Publically available system with little |
| | or no authentication. |

Ve-Vulnerability Exploitability
How easy to exploit the flaw

| | |
|---|---|
| 0 | Purely Theoretical with no practical |
| | exploit |
| 1 | Requires highly specific exploit, with |
| | specific conditions to enable |
| | exploitation |
| 5 | Proof of Concept, with access to |
| | exploit |
| 6 | Semi-capable exploit, may require |
| | tuning to ensure successful |
| | exploitation |
| 10 | Off the shelf exploit available, |
| | capable of running in all situations |
| | with high degree of success |

Va-Vulnerability Awareness
How well known is the flaw

| | |
|---|---|
| 1 | Purely Theoretical |
| 3 | Vulnerability information in closed |
| | circles |
| 5 | Limited Publically available |
| | information |
| 6 | Widely publicised vulnerability with |
| | some awareness |
| 10 | Highly publicised vulnerability |
| | information with high degree of |
| | awareness |

Vc-Vulnerability Countermeasure
Whether a countermeasure exists

| | |
|---|---|
| 1 | Vendor supplied fix exists |
| 3 | Widely supported work around |
| | exists |
| 5 | Work around or unsupported fix |
| | exists |
| 6 | Control or work around exists |
| 10 | No fix or countermeasure exists |

where, for example:

Vulnerability Exposure=(Vd+Ve+Va+Vc)/4

Threat Intelligence

Advanced embodiments of the security system 10 have the prioritisation engine 40 receiving an additional feed(s) of threat intelligence 42, parsing the feeds to determine threats, classifying and mapping the threats to vulnerabilities and further modifying the risk ratings. Preferably, this is done in real-time.

Various data sources may be used, including:
Commercial threat feed(s), eg. of targeted IPs, flaws, CVEs
Pastebin and other on-line information dumps
Email and account information, especially when relating to an identified some threat type
Manual data entry
News feed(s)

Output from the Prioritisation Engine

Output from Prioritisation Engine (#4):
Threat and Vulnerabilities ordered by risk based on rating and intel feed indicators

System Architecture

FIG. 10 shows typical high level system architecture for the computer system 10.

FIG. 11 shows details of the tenancy architecture.

Particular features of interest include:
multi-tenant architecture
web-based or app on user device
provided as a software-as-a-service (SaaS)
connections via APIs, engine effectively as black box
delivered as a physical or virtual appliance, as an on-premise or private cloud solution

Further details of the design and architecture information for the Advisory platform and other aspects of the software implementation are described in the following.

Multi Tenancy Architecture for MSSP/CI Model

First Level

Sub Domain/Domain level multi tenancy, here MSSP or CI tenant data is selected. This equates to a PostgreSQL Schema at a DB level for segregation of client information at the MSSP/CI level.

Users implemented at this level as Admin Users, to be used by the Admin system app (separate URL), but not usable for auth on MSSP/CI instances.

Second Level

Account/Enterprise level multi tenancy, here clients of each MSSP or CI are separated out. Account/Enterprise is created and users created under the account.

Multi Tenancy Implementation

Options for this include:
First Level—apartment gem (https://github.com/influitive/apartment)
Second Level—mila gem (https://github.com/dsaronin/milia)

Plugins and Extensions

Plugins and extensions for the platform handle various tasks. They handle mainly non-core functions, such as importing and exporting data. They also handle functions which may need to be configurable, such as ratings for priorities for a given customer as they have different processes for calculation.

The architecture also takes into account the module of the platform under extension. These may be implemented using Ruby namespacing and Rails Engines. All plugins and extensions are implemented as Ruby gems, they are referenced in the Gemfile and installed via bundler.

Basic Plugin Structure

Basic structure is demonstrated by the dummy importer plugin:

(https://github.com/mort666/advisory_dummy_importer)

The following shows the basic definition of a plugin engine, things like additional rails routes can be defined here as well as other functions. Plugins and Extensions could implement multiple functions, such as an Excel plugin handling both import and export of data. The Namespacing used to differentiate the functionality.

Engine Definition

require ‘advisory_dummy_importer/import’
module Plugins

module VulnMan

module Import

class Engine < ::Rails::Engine

initialiser “static assets” do |app|

app.middleware.insert_before ::Rack::Lock,
::ActionDispatch::Static, “#{

end

end
class DummyImport

include DummyImporter

end

end

end

end

Version Definition

module Plugins

module VulnMan # Namespace of the Vunerability Management

Platform module Dummy

PLUGIN VERSION = “0.0.1”

end

end

end

Basic Functionality Implementation

module DummyImorter

private
@@logger = nil
public

SHORTNAME = “DUMMY”

Name = “Plugin Framework - Dummy Import Plugin”
def options

options = Hash.new
options[:name] = Plugins::VulnMan::Import::DummyImport::NAME
options[:shortname] = Plugins::VulnMan::Import::Import::SHORTNAME
options[:version] = Plugins::VulnMan::Dummy::PLUGIN_VERSION
options[:description] = “Advisory SaaS Plugin Framework -Dummy Import Plugi
return options

end
def import(params={ })

@@logger = params.fetch(:logger, Rails.logger)
# Perform Import Functiom
return true

end

end

Namespaces

All plugin and extension namespace for modules should have the form:

module Plugin

module <platform module>

module <plugin function>

class <plugin classname>
end

end

end

end

Allowable platform module names are (additional platform module names may be added):
VulnMan—Vulnerability Management Platform Module (License option);
ThreatModel—Threat Modelling Platform Module (License option);
ThreatIntel—Threat Intel Platform Module (License option);
Core—Core Platform Module (Cannot be licensed).

Allowable plugin functions are:
Reports—Reporting and report generation plugins;
Import—Importers for external data plugins;
Export—Exporters for platform data plugins to other formats;
Extension—General extensions that add functionality to platform.

The extensions management code will look for extensions under these namespaces Version numbering should take the form:
Plugins::<platform module>::<plugin function>::PLUGIN_VERSION

Required Functions

Each plugin or extension has predefined minimum functions, all plugins preferably have have these minimum functions defined.

Each plugin will provide some minimum information to the extensions manager (ExtensionController) through a method that is defined called options.

SHORTNAME = “DUMMY”
NAME = “Plugin Framework − Dummy Import Plugin”
def options

options = Hash.new
options[:name]= Plugins::<platform module>::<plugin function>::<plugin classname>::NAME
options[:shortname]= Plugins::<platform module>::<plugin function>::<plugin classname>
options[:version]= Plugins::<platform module>::<plugin function>::PLUGIN_VERSION
options[:description]=”Advisory SaaS Plugin Framework − Dummy Import Plugin basic funct

end

Extensions have a slightly different method of implementing the Extension options function. This is because Extensions can be used to house multiple plugins.

An Extension preferably implements a Details Class within the module definition. This may look something like the following:

module Plugins

module <platform module>

module Extension

module <plugin module name>
class Details

SHORTNAME = “EXTENSION”
NAME = “Advisory SaaS Plugin Framework Dummy Extension”

def options

options = Hash.new
options[:name] = Plugins::<platform module>::Extension::<plugin module name>
options[:shortname] = Plugins::<platform module>::Extension::<plugin module name
options[:version] = Plugins::<platform module>::<plugin module name>::PLUGIN
options[:description] = “Advisory SaaS Plugin Framework − Dummy Extension ba
return options

end

end
class Core

include <Functionality Including Class Name>

end

end

end

end

end

end

Plugin Type Specific

For a plugin or extension implementing import functionality it preferably has an import method that takes a params hash.

def import(params={ })

@@logger = params.fetch(:logger, Rails.logger)
#Implementation of import functionality

end

For a plugin or extension implementing export functionality it preferably has an ‘export’ method that takes a params hash.

def export(params={ })

@@logger = params.fetch(:logger, Rails.logger)
#Implementation of export functionality

end

For a plugin or extension implementing reporting functionality it preferably has a ‘report’ method that takes a params hash.

def report(params={ })

@@logger = params.fetch(:logger, Rails.logger)
#Implementation of reporting functionality

end

Extensions implementing more generic functionality may not need to export a specific ‘extension’ method, they may implement other functions such as import and export as well as other functionality such as specific screens to handle interaction with user.

Typically they will implement a ‘launcher’ function while can be used to call specific methods that are not standardised across extensions of a given type. This launcher function is held within a class named Core within the plugin.

class Core

def report(params={ })

@@logger = params.fetch(:logger, Rails.logger)
# Code to handle invocation of extension specific methods

end

end

Modification of Core Platform

View Modification

Within the core Advisory SaaS platform some screens are implemented and will be intended to be altered an extended by plugins and extensions.

To facilitate this we use the ‘deface’ gem (https://github.com/spree/deface), this allows you to override and extend views.

Model Modification

Existing models should be modified using ActiveSupport::Concern within the specific model to add a method to added to an extended instance variable.

after_initialize :extended_model_identifier

def etended model identifier

self.extended = [“model identifier short name”]

end

This method is used to tell the core platform code if the model has been extended, specific functionality may be disabled or enabled if the appropriate extensions have been applied to the model.

Extension Service API

The Extension Service API provides a means to enumerate the available extensions and verify the license status of the enumerated APIs.

The following methods are implemented to return an array of available extensions:
get_vulnman_reporters
get_vulnman_importers
get_vulnman_exporters
get_vulnman_extensions
get_threatmodel_extensions

The Extensions service object should be initialized as follows:

Extensions.new(:licence=>Enterprise.license)

The current data model structure from the platform code is stored in the doc directory of the repo, it is generated by railroady from the models in the platform.

Protection of Client Data

In Transit

SSL/TLS is preferably used for connections to all Web and API Interfaces

There are five protocols in the SSL/TLS family: SSL v2, SSL v3, TLS v1.0, TLS v1.1, and TLS v1.2. Of these:
SSL v2 is insecure and is preferably not used.
SSL v3 is insecure when used with HTTP and weak when used with other protocols.

It's also obsolete, which is why it shouldn't be used.
TLS v1.0 is largely still secure
TLS v1.1 and v1.2 are without known security issues.

TLS v1.2 is therefore preferred as the main protocol.

Interconnections

Where possible connections between systems should be encrypted. Using SSL/TLS enabled versions of protocols for connecting to application components.

Data at Rest

All data when at rest is preferably encrypted.

Servers should have encrypted data disk partitions.

Database platform preferably supports encryption of data held within the database.

Background Job Processing

Within the architecture there will be various elements where background jobs will be required.

Database Platform

Database platform is PostgreSQL (http://www.postgresql.org)

Multi-Tenancy Support

PostgreSQL SCHEMA will be used as part of the multi-tenancy implementation.

Performance

Indexing some elements of the application infrastructure will be requires to query and handle complex queries against large datasets, using PostgreSQL's advanced indexing and querying functionality vastly improves performance.

Connection Security

All connections to PostgreSQL can be secured using ACLs built into the platform and encryption enabled to ensure data is encrypted in transit.

Clustering

PostgreSQL is easily clustered and put into a scalable state.

Caching Models

Several options exist, model cache should be employed to improve performance. Redis or Memcache with Dali=are options.

Redis is a excellent option as it is likely it will be employed if any background job processing is performed within the architecture using resque or Sidekiq Redis will be installed already. Redis is good as it is a in memory data store so is quick with disk persistence.

Memcache with Dali is often used and will achieve much the same results.

Authentication

Authentication to be implemented using the devise gem.

Authorisation

Users are assigned to teams, teams are given access to Threat Models and Vulnerabilities. Some roles assigned to user have access to all threat and vulnerability information.

Combination of the Pundit gem and Royce.

Pundit provides policy based authorisation at a per model and controller level, through defined policies.

Royce provides roles within the user model. This is combined with the pundit policy implementation to provide the full control.

Roles

The following roles are defined for an Enterprise:
CI Admin—CI Administrator user (all tenant account)
MSSP Admin—MSSP Administrator user only allowed to work within MSSP tenant
Account Administrator—Enterprise Administrator can create accounts (cannot view modify any data)
Security Lead—Security team member for Enterprise, full account to threat models and vulnerabilities
Audit—Enterprise auditor, allowed to view audit information
Risk Approver—Risk Approver, allowed to accept risk for mitigations or controls for a threat model
Project Lead—Project lead, allowed to manage any threat models for the a team
User—Standard user attached to an Enterprise (Read/Write Account, always assigned to a team)
Read Only—Read Only Account

Role Matrix

| | CI | MSSP | Account | Security | | Risk |
|---|---|---|---|---|---|---|
| Task | Admin | Admin | Admin | Lead | Audit | Approver |
| Create | Yes | Yes | No | No | No | No |
| Enterprise | | | | | | |
| Manage | Yes | Yes | Yes | No | No | No |
| Enterprise | | | | | | |
| Manage | No | No | Yes | Yes* | No | No |
| Enterprise | | | | | | |
| Users | | | | | | |
| Manage | No | No | Yes | Yes* | No | No |
| Enterprise | | | | | | |
| Teams | | | | | | |
| Create | No | No | No | Yes* | No | No |
| Threat | | | | | | |
| Model | | | | | | |
| Manage | No | No | No | Yes* | No | No |
| Threat | | | | | | |
| Model | | | | | | |
| View | No | No | No | Yes* | Yes | Yes |
| Threat | | | | | | |
| Model | | | | | | |

*Allowed to access all

Teams

Teams own Threat Models and Vulnerabilities.

Security Leads have access to all Threat Models and Vulnerabilities.

When creating an enterprise two default teams should be created.
Security Leads
All Users (default group for all enterprise users)

Platform API

Advisory SaaS platform has an API designed to allow access to key functionality.

API is a fully versioned RESTful API, authenticated using OAuth and Access Tokens. Built on top of the core platform. Extensions to the platform such as the Threat Modelling extensions would extend the API to allow access to functionality within those extensions.

Core Functions to be included within the API are:
Vulnerability Management
   Create/Edit/View Vulnerabilities
   Add notes and additional information to Vulnerabilities
   Manage components of Vulnerabilities such as ratings and functionality provided by Plugins/Extensions
Threat Model Management
   Create/Edit/View Threat Models
   Access Controls, Use Cases, Security Requirements and other component elements of Threat Models
   Access core threat modelling engine functions such as the decisions engines
Threat Intel Access
   Read Only access to threat intelligence information
   Access to Threat Intelligence modified threats and vulnerabilities

Implementation Options

Use a framework such as Versionist (https://github.com/bploetz/versionist) or Grape (https://github.com/ruby-grape/grape) to implement the API.

Authentication

API should be authenticated and managed by a API access token or OAuth token linked to a user account.

API enabled user account privileges are applied to the API, therefore if a user has a given set of access rights those are inherited by the API access ‘token’.

Possible implementation methods using Doorkeeper (https://github.com/doorkeeper-gem/doorkeeper) or similar framework.

Data Formats

API preferably returns JSON data objects when returning information to the API user.

When accepting information to be submitted, information is accepted in JSON or normal multipart-form formats.

Record Revision History

Each core record for Threat Models and Vulnerabilities should have a revision history. To Implement this the revision history functionality is provided through the use of ActiveSupport::Concerns

Requirements

Revision history is an audit record and it is not modified by the user directly. User actions within the platform trigger the creation of revision history records.

Revision history records preferably link to the user that performed the action, along with the IP Address from which the request originated.

Revision history records contain a description of the action, this is preferably static, and ideally it should be language independent. Thus the description stored ideally should be a reference to a localisation text key held within the configuration of the platform.

Revision History Records

A revision history record is created for various actions against a record. These include currently:
Record Creation Record
Edit Record Deletion
Mitigation Rejection
Mitigation Review
Mitigation Accept
Mitigation Acceptance
Expiration
Comment
Risk Acceptance
Risk Rejection
Risk Review
Risk Acceptance Expiration

Additional change types may be added.

The revision history records hold the following information:
Unique ID
Change Type—Enum of change reasons
Previous Change ID for record
Record ID
Record Type—Record Type also used to provide scope when accessing history
Description of Change—Not user controlled, this is preferably static within the platform
Time Stamp of Change (Default timestamps for ActiveRecord)
User ID—Set when calling logging function should be ID from current_user
User IP Address—Set when calling logging function
Revision Number—Integer Count
Revision Tag—SHA-2 Hash of Record
Revision History API

The following methods are provided to a model that is implementing revision history:
revision_history Collection of all revision history records for a given model
find_first_revision( ) Finds the first revision history record for the record currently being viewed
find_last_revision( ) Finds the last revision history record for the record currently being viewed
log(change_type, msg, current_user, ip_address) Create a revision history record
   change_type—Change type for Revision
   msg—Description to be written to the revision history record
   current_user—Current User who made the change taken from current_user global
   ip_address—IP Address taken from the request object

To enable the revision history for a model the following should be added to each model.

# Include Revision History

include RevisionHistory

Revision_history(“ModelName”)

This will setup the model for revision history, will configure the association between the revision history model and the model specified.

Revision Description/Message Text

To allow for language agnostic message and descriptions for revision history using the locale framework of rails different description texts are provided under the ‘revisions’ node. The following are examples of provided description texts:
revisions.vulnerability_create
revisions.vulnerability_edit
revisions.vulnerability_delete
revisions.threat_model_create
revisions.threat_model_edit
revisions.threat_model_delete

Notes, Attachments and Screenshots

Some records will require evidence or additional supporting information attached to them to provide additional clarity.

Notes, Attachments and Screenshots are designed to provide this.

Notes

These are additional information attached to the record, a record can have many of these to provide additional information to the original record.

Possible uses include providing notes regarding how to exploit a vulnerability, or notes from a risk review that should be attached to the record to give clarity.

Screenshots

These are supporting evidence for a vulnerability in the main. For example a screenshot to show the successful exploitation of a vulnerability.

Attachments

These are again supporting evidence for a record, could be attached to notes, vulnerabilities and Threat models. In these cases we are looking at information to support the record, such as code examples, data dumps etc.

Implementation

Implemented as a series of ActiveSupport Concerns. These are used to extend the base models.

Notes is a fairly straightforward data model, storing the information provided. Attachments and Screenshots are models to link to externally provided data.

Attachments and Screenshots use Carrierwave to handle the upload and storage of the provided data. Performs validation on the data and handles the storage of the data.

Carrierwave can be used to link to ‘other’ storage such as S3, Rackspace, etc. It can perform handling of screenshot thumbnail creation as a well as ensuring the uploaded content is of the correct type.

Storage

Storage options for screenshots and attachments potentially include: Amazon S3, Openstack Storage (swift), Rackspace, Google Storage and/or Local storage.
Amazon S3
   Pros: Scalable (by Amazon); Low management overhead; Could possibly use redshift?; Shared storage across web infrastructure
   Cons: Cost; Shared External Cloud
Openstack Storage (swift)
   Pros: Scalable (We manage infrastructure scaled by us); Shared storage across web infrastructure; We secure infrastructure
   Cons: Higher Management Overhead for infrastructure
Local storage
   Pros: We secure infrastructure
   Cons: Higher Management Overhead for infrastructure; Storage cannot be easily shared across web infrastructure; Not easily scalable

Licensing

Module Licensing

The following could be considered licensed modules:
Primary Threat Model Engine (STRIDE, TRIKE, PASTA, etc)
Number of Threat Model Engines
Number of Threat Intel Feeds
Licensed Threat Intel Feed List
Licensed Extensions/Plugins List (Importers, Exporters and Extensions)

Other Licensable Items

The following could be additional licensable items:
Number of Threat Models for the Enterprise
Number of Users

Implementation

Some licensable features could be managed through the Pundit policy system.

Module licensing would need to be managed through the Plugin Framework, when the framework identifies available modules to be made available within the application it should do a license check.

License information is held in a single license record attached to the Enterprise record.

License Check API

The following methods are implemented as a service object to perform license checks:
check_threat_model(license, threat_model_engine) Checks the license object and the provided threat modelling engine name to see if licensed, returns true if licensed.
check_extension(license, extension) Checks the license object and the provided
Extension/Plugin name to see if licensed, returns true if licensed.
check_threatintel_feed(license, threatintel_feed) Checks the license object and the provided Threat Intel Feed name to see if licensed, returns true if licensed.

Core Platform Modules

Core Platform Modules are not subject to licensing and as a result are excluded from licensing checks.

Vulnerability References

Vulnerabilities tend to have references provided. They can come from various sources and point to a wide variety of targets.

Within the platform two types of references are implemented. Core References are specific reference sources considered to be core to the industry such as the Mitre CWE list or the CVE Database provided by Mitre. Additional References are those typically provided on an Adhoc basis such as a Vendor Security Advisory or a web blog.

Implementation

Both types are implemented within the platform. To implement the inclusion within standard pages an extension has been implemented to handle the inclusion of the entry elements for both types of reference within forms.

Core References

Core References have a specific model to handle the information. The model includes the following fields:
Name, the title or name of the reference page or information
Description, a short description of the reference (optional)
Reference, the identifier for the reference for example the CWE ID
URL, URL to the reference site, such as link to the CVE database provided by Mitre
Reference Type, a enum of the available core reference types currently supported
   CWE
   CVE
   CAPEC
   Nessus Plugin ID
   Bugtraq ID (BID)
Meta Info, space for additional information

To implement the display of core information an extension is implemented to handle the specifics of display and handling of the information for a given reference type. The extension may also handle specifics around validation of the reference information

Additional References

Additional References have a specific model to handle the information. The model includes the following fields:
Name, the title or name of the reference page or information
Description, a short description of the reference (optional)
Reference, the identifier for the reference for example the CWE ID
URL, URL to the reference site, such as link to the CVE database provided by Mitre
Reference Source, the source of the reference for example REDHAT for a Redhat Vendor advisory
Meta Info, space for additional information

Matching Engine: Flaw Matching

When importing a new flaw or an existing flaw a decision process should be followed to link a incoming flaw with something that exists already within the platform for flaws currently linked to a threat model.

The following decision tree, represents the process of taking a new flaw and the checks against each existing flaw for a threat model to decide if a new flaw should be created or not.

Risk Rating System

Risk ratings are attached to a record. It is possible to have multiple types of risk rating for a record type.

Various Risk Rating systems exist, including DREAD, CVSS and OWASP. They typically have various focuses and are designed for different use cases.

Risk Rating Record

Risk rating records are preferably tenancy aware. Able to be linked to different record types.

Naming convention for the risk rating model should be of the form

class <Name>Rating <ActiveRecord::Base

# Class methods and details

End

Implementation

Risk rating systems are implemented as extensions, they can be available to Vulnerability management and Threat Model core systems. Implementation can be generic for both, but initial Extension scaffold should be used for each core module extension.

Models should be implemented within the extension, migrations created in core through generators. Concerns used to extend core models, with class method helpers to implement the relationships with models a rating is linked to.

To include tenancy functionality the following is preferably included within a model

include MilliaModelHelper
add_tenant

Additionally specific fields should be added to the migration to provide references to the tenancy identifiers.

The standard ‘extended’ functionality should be implemented to allow core to determine what extensions are enabled on a record.

Rating records are linked to parent records through an association, typically a has many one, a rating record should implement a class method helper to include the relationship into the parent this should have the form:

def cvss_rating(record)

has_many :cvss2_rating, −> {where record_type: record.to_s}, class_name: ‘Cvss2Rating
has_many :cvss3_rating, −> {where record_type: record.to_s}, class_name: ‘Cvss3Rating
# Adds details of extension to the core class extended variable
after_initialize :extended_cvss2_rating
after_initialize :extended_cvss3_rating

end

The above is an example taken from the CVSS rating implementation. Within the migration for the rating record specific elements are required to enable the linkage to the parent.

t.string :record_type
t.belongs_to :record, index: true, foreign_key: true
t.references :tenant

This allows the linkage based on an arbitrary parent, the ‘record_type’ string is passed to the class helper to be used for scoping the record along with the ID value. The belongs_to relationship within the model needs to additionally have the polymorphic option set to true.

The after_initialize statements call a method that appends an identifier to the extended variable that is included in all models that are being extended by an extension. The identified is used to specify the some methods to call and access extension features. It is used to combine with ‘_rating’ to dynamically access the ratings collection and it is used when combined with ‘_snippet’ to reference partials to be used to display the rating.

Ratings models preferably have three additional elements or flags (Boolean values): a primary flag, user_modified and threat_modified flags. These are used to specify if a rating object is the primary or base rating to be used, the user_modified flag is used to show if the rating has been used modified and finally the threat_modified flag will be used by the threat intel based prioritisation engine to mark a rating as modified. These flags should be included in the migration in this form:

t.boolean :primary, default: true
t.boolean :user_modified, default: false
t.boolean :threat_modified, default: false

Displaying Ratings

Within the platform there are places that the rating will be displayed as a result there are several hooks into the extension that should be implemented to allow the displaying of ratings.

There is a helper within the platform that will display a simple rating return this helper will attempt to call a ‘to_s’ method on the rating model, therefore this should be implemented to return a string that will be shown for the rating. This is used on pages such as the Threat and Vulnerability listings.

The to_s method should have the following structure (example fro CVSS 2.0 rating):

def to.s

return “#{self.overall_score}(CVSS v2.0)”

end

Additionally in some areas of the platform more detail maybe required as a result a partial can be implemented and it will be called using a render call to ‘partials/snippet’ within the platform. The identifier is the value from a value used when marking the parent model extended. The snippet to display will be passed a local variable called ‘object’ this will hold the parent model for the rating(s) to be displayed.

Risk Rating System DREAD

DREAD is a classification scheme for quantifying, comparing and prioritizing the amount of risk presented by each evaluated threat. The DREAD acronym is formed from the first letter of each category below.

DREAD modeling influences the thinking behind setting the risk rating, and is also used directly to sort the risks. The DREAD algorithm, shown below, is used to compute a risk value, which is an average of all five categories.

Risk_DREAD=(DAMAGE+REPRODUCIBILITY+EXPLOITABILITY+AFFECTED USERS+DISCOVERABILITY)/5

The calculation always produces a number between 0 and 10; the higher the number, the more serious the risk.

Here are some examples of how to quantify the DREAD categories:

Damage Potential
If a threat exploit occurs, how much damage will be caused?
   0=Nothing
   5=Individual user data is compromised or affected.
   10=Complete system or data destruction

Reproducibility
How easy is it to reproduce the threat exploit?
   0=Very hard or impossible, even for administrators of the application.
   5=One or two steps required, may need to be an authorized user.
   10=Just a web browser and the address bar is sufficient, without authentication.

Exploitability
What is needed to exploit this threat?
   0=Advanced programming and networking knowledge, with custom or advanced attack tools.
   5=Malware exists on the Internet, or an exploit is easily performed, using available attack tools.
   10=Just a web browser

Affected Users
How many users will be affected?
   0=None
   5=Some users, but not all
   10=All users

Discoverability
How easy is it to discover this threat?
   0=Very hard to impossible; requires source code or administrative access.
   5=Can figure it out by guessing or by monitoring network traces.
   9=Details of faults like this are already in the public domain and can be easily discovered using a search engine.
   10=The information is visible in the web browser address bar or in a form.

For existing systems and applications “Discoverability” will be set to 10 by convention, as it is assumed the threat issues will be discovered.

Use Cases

DREAD is originally intended to be used with STRIDE Threat Modelling methodology. DREAD can be used with Vulnerabilities for rating the flaws for severity.

Notes

Using DREAD can be difficult at first. It may be helpful to think of Damage Potential and Affected Users in terms of Impact, while thinking of Reproducibility, Exploitability, and Discoverability in terms of Probability. Using the Impact vs Probability approach (which follows best practices such as defined in NIST-800-30), I would alter the formula to make the Impact score equal to the Probability score. Otherwise the probability scores have more weight in the total.

Implementation

Implemented as a standalone extension, will implement both VulnMan and Threat Model extensions.

Core engine to perform calculation, then input forms to get the various values from the user

Risk Rating System CVSS

This system is developed and maintained by FIRST. Currently in version 3.0 however currently CVSS 2.0 is widespread usage.

CVSS 3.0 is maintained by the CVSS-SIG and is designed to provide ratings for vulnerabilities based on various factors including the availability of exploits and fixes by vendors.

It is mainly used when linked to flaws, it could be used with threats.

CVSS System

CVSS processing handled by cvss_rating ruby gem. Implements both CVSS 2.0 and 3.0 Details of the standard is available at https://www.first.org/cvss

User Interface

FIGS. 12-21 show aspects of the user interface (UI), provided as a web interface or as an app on portable user device such as a smartphone or tablet.

Typically, the UI presents a hierarchy of vulnerabilities/fixes, with vulnerabilities highlighted by priority. Accompanying information provides information on how to address or fix the vulnerability.

FIG. 12 shows an example of the flaw/threat user interface, with an ordered list of vulnerabilities ranked by risk rating.

In some embodiments, vulnerabilities are presented to different users in different ways, with a level of detail dependent on responsibility eg. CIO, IT manger, IT engineer—less technically detailed for those who need only the overview, eg. CIO sees “5 things to protect”; Engineer/technician sees “5 things to do”.

FIGS. 15 and 16 show an example Engineer view. Assigned tasks are displayed and provision is made for the addition of notes and sign-off when vulnerability is fixed.

FIGS. 17, 18 and 19 show an example Manager view. Tasks may be assigned to a selected security engineer, fixes monitored and approved when completed. A retest may also be requested to check whether the vulnerability has indeed been fixed. Individual engineers may be ranked for eg. quality, speed etc and a ‘quality metric’ determined.

FIGS. 20 and 21 show an example CIO view. Here, the display is more graphical eg. pie charts showing % hosts fixed, to allow an overview across the organisation, allowing for quick response in meetings. Further detail may be accessed showing for example the issue, manager responsible—optionally including the ability to contact them directly.

Generally, the preference is to display a short list of essential vulnerabilities rather than an exhaustive list—to counter a problem with some existing security scanning tools which present too much information without context relevant to the specific organisation.

Vulnerabilities may be displayed even if already fixed or only those requiring fixing.

Some embodiments provide Live notifications eg. top 10 threats.

Segregation Tool

Embodiments of security system 10 provide segregation of views according to responsibility, allowing for easier management where some aspects of security are outsourced to third parties. As size of a security team increases, often with geographical separation between team members, it can be important delink a consultant from access vulnerabilities, especially zero-day exploits. By compartmentalising the security analysis all details no longer need to be sent to the consultant—a tick box enables fixes to be applied with full authorisation and auditing.

Where dependencies exist on other threat models—whether within the organisation or external to it—this may be used to allow the system or user access to only a subset of information from the other threat models, eg. indicator(s) of dependencies and/or risk modifiers but not detailed information about threats/vulnerabilities.

Feedback

Embodiments of security system 10 provide tracking of the progress of fixes/patches being applied, eg. the percentage of vulnerabilities fixed. Lists of identified vulnerabilities are updated as they are fixed.

The system also provides re-scanning as confirmation. Optionally, where a rescan shows a vulnerability remaining unfixed despite an earlier prioritisation its subsequent risk rating may be increased, especially where a time-to-fix requirement is mandated.

Where multiple organisations make use of the security system an anonymised comparison with peer organisation, benchmarking

Threat Feed Quality Assessment

Data feeds of threats/vulnerabilities supplied by security consultancies can be expensive. The security system 10 may also allow for the evaluation and/or comparison of feeds, whether generally or in respect of to specific threats for the particular organisation.

Where multiple threat/vulnerability feeds are input, the feeds are scored according to number/type of threat identified by each feed. Metrics may be reported at each stage of the threat assessment, eg. an initial score for identified threats, a revised score for relevance.

An organisation may therefore find a subset of the feeds will suffice for those threats of particular relevance, saving considerable financial outlay.

For example, say an organisation has four threat intelligence feeds—A, B, C and D—each costing $100,000 per year. By using the security system 10, these feeds may be scored as: A—94, B—86, C—45, D—23. Cross correlation of the feeds may also be performed. For example, 100% of feed D may be determined to be contained within the content of feed A. Thus by measuring identified threats and vulnerabilities and or relevance the organisation may likely decide to keep only feeds A and B, saving $200,000 per year.

A system threat feed efficiency (Tfe) may be defined as, for example:

$$Tfe = ( ( \frac{( Ta + Va}{Tma} ) * \frac{Re}{Te} ) * 100$$

where
   Te=Total entries
   Re=relevant entries
   Ta=Threats affected
   Va=Vulnerabilities affected
   Tma=Threat Models affected
each within a specified/measured time window.

A data-point threat feed efficiency DpTfe may also be defined as, for example:

$$DpTfe = ( Dp * ( Re \text{/} Te ) ) * 100$$

where Dp could be any one of Va, Ta or Tma.

When comparing feeds, each feed is represented by a single score for the system threat feed efficiency Tfe, and a graph showing data-point scores Dp over time.

In summary, system 10 may be used to identify (for a monitored period) how often a feed is used and how much of the feed was used, hence how many entries were retrieved and how many of those were used, and in turn how many threats or vulnerabilities were affected by the used entries.

Conversely, this may also enable data feed providers to better communicate their effectiveness and relevance to organisations.

It will be understood that the invention has been described above purely by way of example; modifications of detail can be made within the scope of the invention.

Reference numerals appearing in any claims are by way of illustration only and shall have no limiting effect on the scope of the claims.

What is claimed is:

1. A computer security system, comprising:
a first input, adapted to receive threat data representing security threats;
a second input, adapted to receive vulnerability data representing security vulnerabilities;
a processor (implemented, for example, as a mapping engine on a computer server) adapted to:
identify a specific vulnerability of a computer entity in dependence on the threat data and the vulnerability data;
assign the specific vulnerability a risk rating in dependence on the vulnerability data and the threat data; and
generate output data comprising an identifier of the specific vulnerability and its risk rating.

2. A computer security system according to claim 1, wherein the processor is adapted (for example, by means of a prioritisation engine implemented as a further or as part of the same computer server) to identify a plurality of specific vulnerabilities of the computer entity and to generate output data comprising a list of identifiers of the specific vulnerabilities ordered according to their risk rating.

3. A computer security system according to claim 1 or 2, wherein the processor is adapted to identify a mitigation for the or a specific vulnerability and to incorporate details of the mitigation with the output data.

4. A computer security system according to claim 3, further comprising means for interacting with the computer entity to implement the mitigation.

5. A computer security system according to any preceding claim, wherein the threat data comprises an organisational data feed relating to the organisation of which the computer entity is a part, and the processor is adapted (for example, by means of a threat modelling engine, implemented as a further or as part of the same computer server) to determine from the organisational data feed a threat model of potential threats to the computing entity, each threat being associated with a threat risk rating.

6. A computer security system according to claim 5, wherein the organisational data feed comprises one or more of information relating to: security or regulatory requirements, use cases or functional requirements, business assets, external dependencies and controls or mitigations.

7. A computer security system according to claim 5 or 6, wherein the processor is adapted to categorise the threats in the threat model according to one or more of: threat type, source, target, technology, and timeliness.

8. A computer security system according to claim 7, wherein the categorisation of the threats is according to an industry-standard model, for example one or more of STRIDE, OctoTrike, PASTA, ASF and OWASP.

9. A computer security system according to any preceding claim, further comprising a manual input, adapted to receive manual modification or approval of one or more of: threat and vulnerability data, threat model, and risk ratings.

10. A computer security system according to any preceding claim, wherein the processor is adapted (for example, by means of a vulnerability matching engine, implemented as a further or as part of the same computer server) to receive a vulnerability data feed from a computer entity vulnerability source, and to maintain a database of vulnerabilities.

11. A computer security system according to claim 10, wherein the vulnerability data feed originates from a vulnerability scanning tool.

12. A computer security system according to claim 10 or 11, wherein updates to the database of vulnerabilities from the vulnerability data feed are determined by fuzzy-matching with a decision tree.

13. A computer security system according to any of claims 10 to 12, wherein the vulnerability data feed includes a vulnerability risk rating and the processor is adapted to import and use the vulnerability risk rating in determining the threat risk rating.

14. A computer security system according to any preceding claim, further comprising:
a third input, adapted to receive a threat intelligence data feed;
wherein the processor is adapted to modify the risk rating in dependence on threat intelligence data determined from the threat intelligence data feed.

15. A computer security system according to claim 14, wherein the threat intelligence data feed comprises information on threats recently or currently being exploited.

16. A computer security system according to claim 14 or 15, wherein the system is further adapted to assess the quality of the threat intelligence data feed.

17. A computer security system according to any of claims 14 to 16, wherein the system is further adapted to receive a plurality of threat intelligence data feeds and to compare at least one feed against another.

18. A computer security system according to any preceding claim, wherein at least one data feed comprises text data and the processor is adapted use natural language processing to parse and determine information from the data feed.

19. A computer security system according to claim 18, wherein the natural language processing comprises one or more of: Bayesian, TF-IDF, Recurrent Neural Network and Support Vector Machines models for Natural Language Processing.

20. A computer security system according to any preceding claim, wherein the processor is adapted to transmit the output data to a mobile device, such as a laptop, tablet or smartphone.

21. A computer security system according to any preceding claim, wherein the processor is adapted to adapt the output data according to the status of a user of the system.

22. A computer security system according to any preceding claim, wherein the processor is adapted to assign a user to mitigate the specific vulnerability.

23. A computer security system according to claim 22, wherein the processor is adapted to receive feedback from the user on the mitigation of the specific vulnerability.

24. A method of operating a computer security system, comprising:
receiving, at a first input, threat data representing security threats;
receiving, at a second input, vulnerability data representing security vulnerabilities;
identifying a specific vulnerability of a computer entity in dependence on the threat data and the vulnerability data;
assigning the specific vulnerability a risk rating in dependence on the vulnerability data and the threat data; and
generating output data comprising an identifier of the specific vulnerability and its risk rating.

25. A method according to claim 24, further comprising identifying a plurality of specific vulnerabilities of the computer entity and generating output data comprising a list of identifiers of the specific vulnerabilities ordered according to their risk rating.

26. A method according to claim 24 or 25, further comprising identifying a mitigation for the or a specific vulnerability and incorporating details of the mitigation with the output data.

27. A method according to claim 26, further comprising interacting with the computer entity to implement the mitigation.

28. A method according of claims 24 to 27, wherein the threat data comprises an organisational data feed relating to the organisation of which the computer entity is a part, the method further comprising determining from the organisational data feed a threat model of potential threats to the computing entity, each threat being associated with a threat risk rating.

29. A method according to claim 28, wherein the organisational data feed comprises one or more of information relating to: security or regulatory requirements, use cases or functional requirements, business assets, external dependencies and controls or mitigations.

30. A method according to claim 28 or 29, further comprising categorising the threats in the threat model according to one or more of: threat type, source, target, technology, and timeliness.

31. A method according to claim 30, wherein categorising the threats is in accordance with an industry-standard model, for example one or more of STRIDE, OctoTrike, PASTA, ASF and OWASP.

32. A method according to any of claims 24 to 31, further comprising receiving manual modification or approval of one or more of: threat and vulnerability data, threat model, and risk ratings.

33. A method according to any of claims 24 to 32, further comprising receiving a vulnerability data feed from a computer entity vulnerability source and maintaining a database of vulnerabilities.

34. A method according to claim 33, wherein the vulnerability data feed originates from a vulnerability scanning tool.

35. A method according to claim 33 or 34, wherein further comprising determining updates to the database of vulnerabilities from the vulnerability data feed by fuzzy-matching with a decision tree.

36. A method according to any of claims 33 to 35, wherein the vulnerability data feed includes a vulnerability risk rating and the method further comprises importing and using the vulnerability risk rating to determine the threat risk rating.

37. A method according to any of claims 24 to 36, further comprising:
receiving a threat intelligence data feed; and
modifying the risk rating in dependence on threat intelligence data determined from the threat intelligence data feed.

38. A method according to claim 37, wherein the threat intelligence data feed comprises information on threats recently or currently being exploited.

39. A method according to claim 37 or 38, further comprising assessing the quality of the threat intelligence data feed.

40. A method according to any of claims 37 to 39, further comprising receiving a plurality of threat intelligence data feeds and to comparing at least one feed against another.

41. A method according to any of claims 24 to 40, wherein at least one data feed comprises text data and the method further comprises using natural language processing to parse and determine information from the data feed.

42. A method according to claim 41, wherein the natural language processing comprises one or more of: Bayesian, TF-IDF, Recurrent Neural Network and Support Vector Machines models for Natural Language Processing.

43. A method according to any of claims 24 to 42, further comprising transmitting the output data to a mobile device, such as a laptop, tablet or smartphone.

44. A method according to any of claims 24 to 43, further comprising adapting the output data according to the status of a user of the system.

45. A method according to any of claims 24 to 44, further comprising assigning a user to mitigate the specific vulnerability.

46. A method according to claim 45, further comprising receiving feedback from the user on the mitigation of the specific vulnerability.
